(19) United States
(12) Patent Application Publication
(10) Pub. No.: US 2026/0083240 A1
(43) Pub. Date: Mar. 26, 2026

(54) ORAL CARE DEVICE, INFORMATION DISPLAY DEVICE THEREOF, AND INFORMATION DISPLAY METHOD THEREOF

(71) Applicant: GUANGZHOU STARS PULSE CO.,LTD., GUANGZHOU (CN)

(72) Inventors: WENQIANG LIN, GUANGZHOU (CN); YUCHEN ZOU, GUANGZHOU (CN); KEBI DING, GUANGZHOU (CN); KAI LI, GUANGZHOU (CN)

(21) Appl. No.: 19/405,593

(22) Filed: Dec. 2, 2025

Related U.S. Application Data
(63) Continuation-in-part of application No. PCT/CN2023/133316, filed on Nov. 22, 2023.

(30) Foreign Application Priority Data
Jun. 2, 2023 (CN) 202310655436.3
Jul. 28, 2023 (CN) 202322018407.4
Aug. 3, 2023 (CN) 202322083276.8

(51) Int. Cl. A46B 15/00; A61C 17/22; H05B 47/115; H05B 47/16

(52) U.S. Cl. CPC A46B 15/0044; A46B 15/0006; A46B 15/0008; A61C 17/225; H05B 47/115; H05B 47/16

(57) ABSTRACT

An oral care device, an information display device thereof, and an information display method thereof are provided. The information display method is applied to the oral care device. The oral care device includes display areas respectively configured to display information of oral care positions. The information display method includes: determining a current oral care position of the oral care device and a current oral care duration corresponding to the current oral care position; when the current oral care duration is less than a predetermined duration corresponding to the current oral care position, controlling a display area corresponding to the current oral care position to display in a first manner; and when the current oral care duration is not less than the predetermined duration corresponding to the current oral care position, controlling the display area corresponding to the current oral care position to display in a second manner.

### TECHNICAL FIELD

The present disclosure relates to a technical field of oral care, and in particular to an oral care device and an information display device thereof, and information display method thereof.

### BACKGROUND

Tooth decay is a common oral health problem. Due to dietary and brushing habits, tooth decay is more prevalent among children. Results of the Fourth National Oral Health Epidemiological Survey in China show that a prevalence of dental caries in permanent teeth among 12-year-old children in China is 34.5%, an increase of 7.8 percentage points compared to 10 years ago, and a prevalence of dental caries in deciduous teeth among 5-year-old children is 70.21%, an increase of 5.8 percentage points compared to 10 years ago. The current situation of dental caries among children in China is serious.

There are many ways to prevent tooth decay, such as plaque control, controlling the intake of sugar and sugar substitutes, and strengthening the tooth resistance to decay. Specifically, removing the plaque through mechanical methods (brushing, etc.) is the simplest and most effective self-care method. However, during a process of learning to brush the teeth, children commonly resist brushing due to improper brushing techniques and the strong foreign body sensation they experience, resulting in low willingness to brush.

### SUMMARY

The present disclosure provides an oral care device, an information display device thereof, and an information display method thereof. By displaying different effects in different display areas, a user is able to know whether a current oral care position is properly cared for, which encourages the user to complete sufficient oral care time in the current oral care position, reduces plaque in the current oral care position, reduces a risk of tooth decay, and develops correct oral care habits for the user. In particular, the present disclosure prevents children from being careless when performing oral care.

In a first aspect, the present disclosure provides an information display method of an oral care device. The information display method is applied to the oral care device. The oral care device comprises display areas. The display areas respectively display information of oral care positions. The information display method comprises:
determining a current oral care position of the oral care device, and determining a current oral care duration corresponding to the current oral care position;
when the current oral care duration is less than a predetermined duration corresponding to the current oral care position, controlling a display area corresponding to the current oral care position to display in a first manner; and
when the current oral care duration is not less than the predetermined duration corresponding to the current oral care position, controlling a display area corresponding to the current oral care position to display in a second manner.

A display effect of the first manner is different from a display effect of the second manner.

In a second aspect, the present disclosure provides the oral care device. The oral care device comprises display areas, a handle and a brush head. The display areas respectively display information of oral care positions. A button is disposed on the handle. The display areas are defined on a surface, where the button is located, of the handle. The display areas are located between the brush head and the button. The display areas are distributed according to a distribution of the oral care positions.

In one or more embodiments of the present disclosure, the current oral care position of the oral care device is determined, and the current oral care duration corresponding to the current oral care position is determined, and when the current oral care duration is less than the predetermined duration corresponding to the current oral care position, a display area corresponding to the current oral care position is controlled to display in the first manner. Alternatively, when the current oral care duration is not less than the predetermined duration corresponding to the current oral care position, a display area corresponding to the current oral care position is controlled to display in the second manner. The display effect of the first manner is different from the display effect of the second manner.

In this way, the display effect of the display area corresponding to the current oral care position is able to notify the user whether the current oral care position is properly cared for. Therefore, the user is encouraged to complete sufficient oral care duration in the current oral care position, thereby reducing the plaque in the current oral care position and reducing a risk of tooth decay. In addition, interest of the user in oral care is stimulated by displaying different display effects corresponding to the oral care positions in different display areas. In this way, the user is well guided to spend enough time caring for each of the oral care positions and clean each of the oral care positions, thus developing the correct oral care habits for the user.

The above description is only an overview of technical solutions of the present disclosure. In order to more clearly understand technical means of the present disclosure, the present disclosure is implemented in accordance with contents of the specification. In order to make the above and other purposes, features, and characteristics of the present disclosure more obvious and easy to understand, the specific implementation methods of the present disclosure are listed below.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of a first embodiment of an oral care device according to one embodiment of the present disclosure.

FIG. 2 is another structural schematic diagram of the first embodiment of the oral care device according to one embodiment of the present disclosure.

FIG. 3 is a structural schematic diagram of a second embodiment of the oral care device according to one embodiment of the present disclosure.

FIG. 4 is a structural schematic diagram of a third embodiment of the oral care device according to one embodiment of the present disclosure.

FIG. 5 is a structural schematic diagram of a fourth embodiment of the oral care device according to one embodiment of the present disclosure.

FIG. 6A is a structural schematic diagram of a first embodiment of a handle of the oral care device according to one embodiment of the present disclosure.

FIG. 6B is a structural schematic diagram of a second embodiment of the handle of the oral care device according to one embodiment of the present disclosure.

FIG. 7 is a cross-sectional schematic diagram of the first embodiment of the handle of the oral care device according to one embodiment of the present disclosure.

FIG. 8 is an exploded schematic diagram of the handle of the oral care device according to one embodiment of the present disclosure.

FIG. 9 is a schematic diagram of a light-transmitting area of the oral care device according to one embodiment of the present disclosure.

FIG. 10 is a schematic diagram of a first embodiment of light-transmitting sub-areas of the oral care device according to one embodiment of the present disclosure.

FIG. 11 is a schematic diagram of a second embodiment of the light-transmitting sub-areas of the oral care device according to one embodiment of the present disclosure.

FIG. 12 is a schematic diagram of a projection plane perpendicular to a central axis of the light-transmitting area and an outer edge of the light-transmitting area and an outer edge of a housing within the projection plane according to one embodiment of the present disclosure.

FIG. 13 is a flow chart of an information display method of the oral care device according to one embodiment of the present disclosure.

FIG. 14 is another flow chart of the information display method of the oral care device according to one embodiment of the present disclosure.

FIG. 15 is a schematic diagram of a display effect of the oral care device according to one embodiment of the present disclosure.

FIG. 16 is another flow chart of the information display method of the oral care device according to one embodiment of the present disclosure.

FIG. 17 is a schematic diagram of an implement process of the information display method of the oral care device according to one embodiment of the present disclosure.

FIG. 18 is another flow chart of the information display method of the oral care device according to one embodiment of the present disclosure.

FIG. 19 is another flow chart of the information display method of the oral care device according to one embodiment of the present disclosure.

FIG. 20 is a block diagram of an information display device of the oral care device according to one embodiment of the present disclosure.

FIG. 21 is another block diagram of the information display device of the oral care device according to one embodiment of the present disclosure.

### DETAILED DESCRIPTION

In order to make purposes, features, and advantages of the present disclosure obvious and understandable, technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

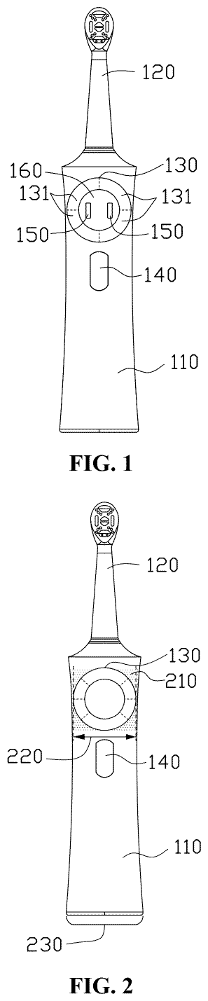

In one embodiment, the present disclosure provides an oral care device. The oral care device is a device capable of performing oral care, such as, but not limited to an electric toothbrush, a dental cleaning instrument, etc. The following embodiments take an example that the oral care device is the electric toothbrush for illustration. FIG. 1 is a structural schematic diagram of the oral care device according to one embodiment of the present disclosure. As shown in FIG. 1, the oral care device comprises a handle 110, a brush head 120, and display areas 130.

The handle 110 is configured for a user to hold, and the display areas 131 are disposed on the handle 110. The display areas are configured to respectively display information of oral care positions. A button 140 is disposed on the handle 110. To make it easy for the user to view information displayed in the display areas during oral care, the display areas 130 are defined on a surface, where the button 140 is located, of the handle 110. The display areas 130 are located between the brush head 120 and the button 140. The display areas are distributed according to a distribution of the oral care positions. For example, but not limited to, when one of the oral care positions is in an upper teeth area or within the upper teeth area, a display area 131 corresponding to the one of the oral care positions is positioned close to the brush head 120. That is, when the oral care device is upright, the display area 131 corresponding to the one of the oral care positions is located above other display areas. When the one of the oral care positions is in a lower teeth area or within the lower teeth area, the one of the display area 131 corresponding to the one of the oral care positions is positioned close to the button 140. That is, when the oral care device is upright, the display area 131 corresponding to the one of the oral care positions is located below other display areas. In this way, the user is able to easily identify the oral care positions respectively corresponding to the display areas. By distributing the display areas according to the distribution of the oral care positions, the user is able to intuitively and accurately understand information of each of the oral care positions, which stimulates interest of the user in oral care, guides the user to clean each of the oral care positions, and develops correct oral care habits for the user. The oral care device prevents the user, especially a kid, from being careless when performing oral care.

Specifically, when performing oral care by the oral care device, the oral care device is able to determine a current oral care position of the oral care device, and determine a current oral care duration corresponding to the current oral care position. When the current oral care duration is less than a predetermined duration corresponding to the current oral care position, the oral care devices controls a display area corresponding to the current oral care position to display in a first manner. When the current oral care duration is not less than the predetermined duration corresponding to the current oral care position, the oral care device controls the display area corresponding to the current oral care position to display in a second manner. A display effect of the first manner is different from a display effect of the second manner. By displaying different display effects in different display areas, the user is able to know whether the current oral care position is properly cared for, which encourages the user to complete sufficient oral care time in the current oral care position, reduces plaque in the current oral care position, reduces a risk of tooth decay, and develops correct oral care habits for the user. In particular, the oral care device prevents children from being careless when performing oral care.

Optionally, to ensure continuity between the display areas 131, as shown in FIG. 1, the display areas 131 are connected end to end to form a display ring 130. The display ring 130, composed of the display areas 131, stimulates the interest of the user in oral care, guides the user to spend sufficient time cleaning each of the oral care areas, and develops the correct oral care habits. In addition, the display ring 130 prevents the user, especially the kid, from being careless during oral care. The display ring 130 may be, but is not limited to, a circular ring. The display ring 130 may also be, but is not limited to, an elliptical ring, a polygonal ring, etc., which is not limited thereto.

Furthermore, to make the information displayed in each of the display areas 131 of the display ring 130 easy for the user to observe, a width of the display ring 130 is not less than 1 mm. The width of the display ring 130 is a difference between a maximum diameter of an outer circle and a maximum diameter of the inner circle. For instance, when the display ring 130 is the circular ring, the width of the display ring 130 is the difference between a diameter of the outer circle and a diameter of the inner circle. Moreover, to avoid the display ring 130 being too large, which would hinder the user from observing complete information on the same side of the button 140 on the handle 110, and to avoid affecting esthetics and manufacturing cost of the oral care device, the width of the display ring 130 is configured to be not greater than 3 mm, thereby improving visibility of the oral care device during use.

For instance, the width of the display ring 130 is 2 mm, 2.5 mm, etc., which is not limited thereto.

It is understood that there may be two, four, six or more display areas 13, and a shape of the display ring 130 formed by connecting the display areas end to end maybe circular, rectangular, etc., which is not limited thereto.

In some possible embodiments, the handle 110 comprises a housing. The display ring 130 is light-transmitting and is embedded in the housing. The handle 110 comprises a power component. Light-emitting units corresponding to the display ring 130 are disposed on the power component. When one of the light-emitting units corresponding to a display area 131 of the display ring 130 emits light, the display area 131 lights up. Thus, by providing the display ring 130 and directly exposing the display ring 130 on the surface of the handle 110, the user is allowed to intuitively observe the display ring, further increasing the visibility during the use of the oral care device. The light-emitting units may be, but are not limited to, LED lights.

Optionally, two sub-display areas 150 are disposed within an area enclosed by the display ring. The two sub-display areas 150 are spaced apart in a circumferential direction of the handle 110 and are spaced apart from the display ring. The two sub-display areas 150 are displayed in a fourth manner, thus enabling the display ring 130 and the two sub-display areas 150 to form an interaction effect. Through colored lighting effects and cute expressions, oral care operations are transformed into games, enhancing fun and stimulating the interest of the user, especially the kid, in oral care, thus encouraging the users, especially the kid, to perform oral care.

Optionally, an area between the two sub-display areas 150 and the display areas 131 is a non-display area 160. The non-display area 160 separates the two sub-display areas 150 from the display areas 131, so as to enhance visual appeal of the display areas 131 while maintaining an interactive effect between the two sub-display areas 150 and the display areas 131.

Optionally, display effects of the display areas 131 are different from display effects of the two sub-display areas 150.

It is understood that the two sub-display areas 150 are rectangular, circular, elliptical, etc., which is not limited thereto.

Optionally, the oral care device may comprise, but is not limited to, one or more indicator lights, one or more speakers, one or more motors, etc.

Furthermore, as shown in FIG. 2, an area 210 of the handle on an outer periphery of the display ring 130 may be covered by a flexible rubber sleeve made of a non-transparent material. The flexible rubber sleeve enhances stability of the display ring 130 and highlights a position of the display ring 130, so that the user is allowed to quickly observe the position of the display ring 130.

Furthermore, as shown in FIG. 2, the maximum diameter 220 of the display ring 130 along the circumferential direction of the handle, i.e., the maximum diameter of the outer circle of the display ring 130 may be, but is not limited to, greater than 14 mm. such as 15 mm, 16 mm, 20 mm, etc., making the information displayed in the display ring 130 easy for the user to observe. For instance, when the display ring 130 is the circular ring, the maximum diameter 220 of the display ring 130 along the circumferential direction of the handle is the diameter of the outer circle of the circular ring.

Furthermore, as shown in FIG. 2, a ratio of the maximum diameter 220 of the display ring 130 along the circumferential direction of the handle 110 (i.e., the maximum diameter of the outer circle of the display ring 130, and when the display ring 130 is the circular ring, the maximum diameter 220 along the circumferential direction of the handle is the diameter of the outer circle of the circular ring) to the width 230 of the handle 110 (i.e., a circumferential diameter of the handle 110) is greater than ⅔ and less than 9/10, such as ¾, ⅘, etc., so that the user is able to easily observe the information displayed by the display ring 130 during oral care, and the visibility of the oral care device is improved during use.

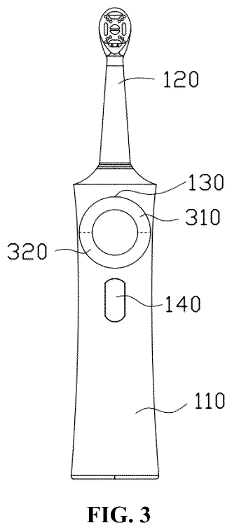

In some optional embodiments, as shown in FIG. 3, the display areas 131 of the oral care device shown in FIG. 1 comprise an upper display area 310 and a lower display area 320. The upper display area 310 is close to the brush head 120, and the lower display area 320 is disposed away from the brush head. A first one of the oral care positions displayed in the upper display area 310 is an upper teeth area, and a second one of the oral care positions displayed in the lower display area 320 is a lower teeth area. By distributing the upper display area and the lower display area according to the distribution of the upper teeth area and the lower teeth area, the user is able to intuitively and efficiently identify the oral care positions (teeth areas) respectively corresponding to the upper display area and the lower display area. The display effects of the upper display area and the lower display area allow the user to accurately understand the oral care information of the upper teeth area and the lower teeth area, so that the user is guided to clean the upper teeth area and the lower teeth area, thereby developing the correct oral care habits. As a result, the user, especially the kid, is no longer careless when performing oral care.

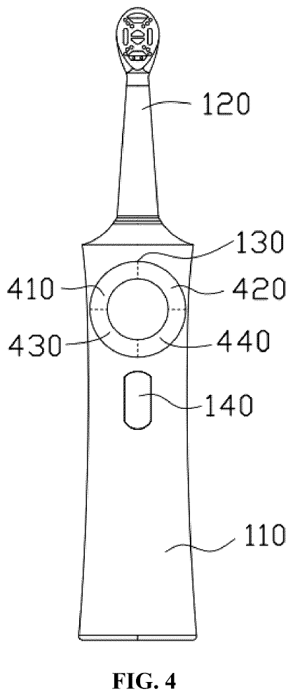

In some possible embodiments, as shown in FIG. 4, the display areas 131 of the oral care device shown in FIG. 1 comprise an upper left display area 410, an upper right display area 420, a lower left display area 430, and a lower right display area 440. The upper left display area 410 and the upper right display area 420 are disposed close to the brush head 120, while the lower left display area 430 and the lower right display area 440 are disposed away from the brush head 120. The upper left display area 410 and the lower left display area 430 are distributed along an axial direction of the handle 110, and the upper right display area 420 and the lower right display area 440 are distributed along the axial direction of the handle 110. The upper left display area 410 corresponds to an upper left teeth area, the upper right display area 420 corresponds to an upper right teeth area; the lower left display area 430 corresponds to a lower left teeth area, and the lower right display area 440 corresponds to a lower right teeth area. By distributing the upper left display area, the upper right display area, the lower left display area, and the lower right display area according to a distribution of the upper left teeth area, the upper right teeth area, the lower left teeth area, and the lower right teeth area. The four display areas provide a more detailed correspondence between the information of the four oral care areas, making it easier for users to intuitively and efficiently identify the oral care positions (teeth areas) respectively corresponding to the upper left display area, the upper right display area, the lower left display area, and the lower right display area. Furthermore, the display effects of the four display areas allow the user to accurately understand the oral care information of the upper left teeth area, the upper right teeth area, the lower left teeth area, and the lower right teeth area, so that the user is guided to perform more refined oral care, thereby developing the correct oral care habits. As a result, the user, especially the kid, is no longer careless when performing oral care.

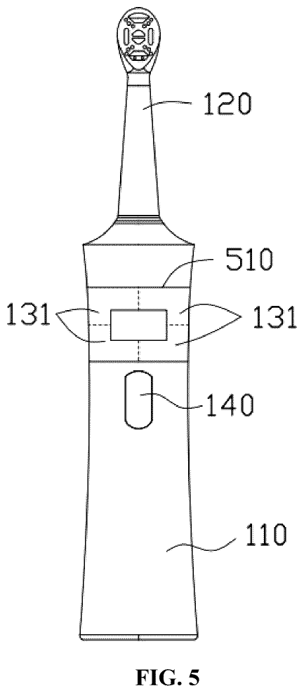

In some possible embodiments, as shown in FIG. 5, the display ring 130 of the oral care device is a rectangular ring 510. A length or a width of the rectangular ring is configured along the axial or circumferential direction of the handle 110, and the four display areas 131 are respectively located at four corners of the rectangular ring 510, thereby ensuring that the user is allowed to intuitively observe a state of each of the oral care positions.

In some optional embodiments, based on the oral care device shown in FIG. 1, the oral care device further comprises at least one of a multi-axis sensor and an accelerometer. The multi-axis sensor or the accelerometer is configured to detect the current oral care position. When the oral care device detects the current oral care position, one of the display areas 131 corresponding to the current oral care position is displayed, thereby notifying the user that the current oral care position is being cared for.

In some optional embodiments, when the oral care device is powered on or running, all of the display areas 131 are lit up. The oral care device is the electric toothbrush.

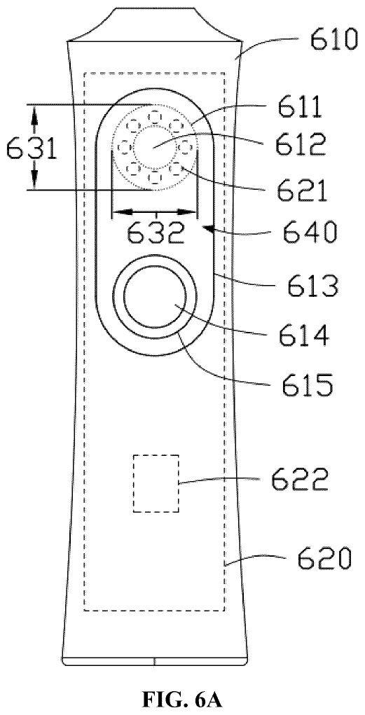

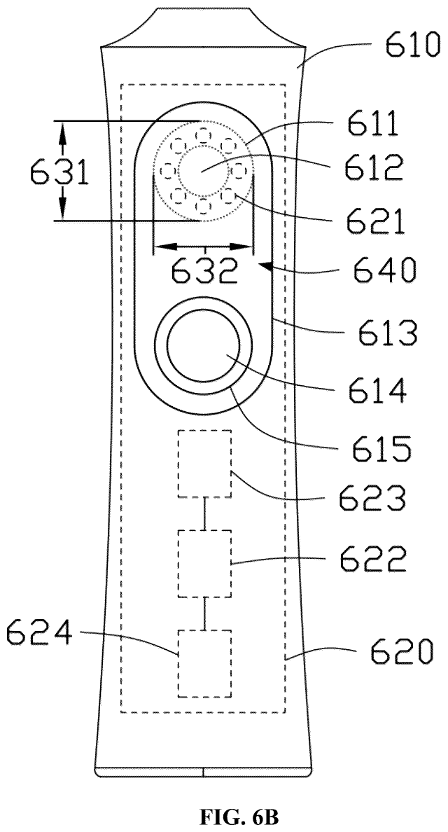

The following describes a handle provided in one exemplary embodiment of the present disclosure. FIG. 6A is a structural schematic diagram of a first embodiment of the handle of the oral care device according to one embodiment of the present disclosure. As shown in FIG. 6, the handle is applied to the oral care devices. The oral care device may be, but is not limited to, an electric toothbrush, a water flosser, etc. As shown in FIG. 6A, the handle comprises: a housing 610 and a power component 620.

The housing 610 defines a light-transmitting area 611. Light-emitting units 621 are disposed on the power component 620. The light-transmitting units are disposed corresponding to the light-transmitting area 611, so that light emitted by the light-transmitting units is allowed to pass through the light-transmitting area 611. Furthermore, the power component 620 comprises a control unit 622 connected to the light-emitting units 621. The control unit 622 is configured to receive current oral care information and control the light-emitting units 621 to perform corresponding tasks, so that the display areas are able to display a current oral care state of the oral care device. In this way, the light-emitting units 621 are allowed to display the current oral care state, as the light emitted by the light-transmitting units passes through the light-transmitting area 611. The light is not blocked by a non-light-transmitting area of the handle, making it easy for the user to observe the current oral care state while stimulating the interest of the user in oral care. As a result, the user is guided to clean each of the oral care positions thoroughly and develop the correct oral care habits, so that the user, especially the child, is no longer careless when performing oral care.

Furthermore, the light-emitting units 621 may be, but are not limited to, LED lights.

Optionally, as shown in FIG. 6B, the power component 620 further comprises a detection element 623. The detection element 623 is connected to the control unit 622 and is configured to detect current oral care information of the oral care device. The detection element 623 may comprise, but is not limited to, an oral care position detection element, an oral care pressure detection element, and an oral care amplitude detection element, etc. The current oral care information may comprise, but is not limited to, the current oral care position, current oral care pressure, etc. In the embodiment, the control unit 622 is configured to control the light-emitting units 621 to display corresponding information based on the current oral care position, the current oral care pressure, or a current oral care amplitude detected by the detection element 623, thereby enabling the user to more easily observe the current oral care position, the current oral care pressure, or the current oral care amplitude through the light-transmitting area.

Optionally, as shown in FIG. 6B, the current oral care information comprises a current oral care duration of the oral care device. The handle further comprises a timer 624. The timer 624 is connected to the control unit 622 and is configured to count the current oral care duration. The control unit 622 controls the light-emitting units to perform corresponding tasks based on the current oral care duration. Thus, the current oral care duration is displayed through the light-emitting units 621, making it easy for the user to observe the current oral care duration.

Furthermore, the control unit 622 is configured to control the light emitted by the light-emitting units to form a corresponding display of a current oral care progress based on the current oral care duration. In this way, the user is allowed to more easily and intuitively observe the current oral care progress through the light-emitting units 621, and the user is guided to perform oral care for a sufficient duration.

Optionally, the light-transmitting area 611 is disposed in a ring. To ensure continuity between a light-transmitting display of the light-emitting units 621 corresponding to the light-transmitting area 611, the light-transmitting area 611 may be a closed ring as shown in FIG. 6A. The light-emitting units 621 are disposed in a ring and corresponding to the light-transmitting area 611, which allows a display range of the light-transmitting area 611 to be larger and makes the information displayed in the light-transmitting area 611 easier to observe.

Optionally, the light-transmitting area 611 is disposed on a curved surface, and an outer surface of the light-transmitting area 611 forms a part of an outer surface of the handle. Compared to displaying the current oral care position through a display screen disposed on the handle, since the outer surface of the light-transmitting area 611 forms a part of the outer surface of the handle, a display content of the light-transmitting area 611 is avoided being blocked by a non-light-transmitting portion of the handle, making the display content displayed in the light-transmitting area 611 easy for the user to observe, further improving the visibility of the oral care device.

Optionally, the light-transmitting area 611 may be, but is not limited to, a circular ring leading to a larger display area, making the information displayed in the light-transmitting area 611 easy to observe, and further enhancing the esthetics and visibility of the oral care device to a certain extent.

It is understood that the light-transmitting area 611 may be, but is not limited to, an elliptical ring or a rectangular ring.

Furthermore, a circular portion 612 enclosed by the light-transmitting area 611 is an opaque housing, or a light-shielding coating is disposed on the circular portion 612, where the circular portion 612 enclosed the light-transmitting area 611 is a surface of the housing that is light-transmitting, so that the light emitted by the light-emitting units are emitted only through the light-transmitting area, which avoids the influence of the circular portion 612 enclosed by the light-transmitting area on the light emission of the light-transmitting area. In this way, the information formed by the light emitted by the light-emitting units is allowed to be displayed centrally through the light-transmitting area, which further improves the visibility of the oral care device.

Optionally, as shown in FIG. 6A, to avoid a problem that a radial width 631 of the light-transmitting area in a radial direction is too small for the user to observe the information displayed in the light-transmitting area, the radial width 631 of the light-transmitting area 611 is greater than 1 mm. To avoid a problem that the radial width of the light-transmitting area is too large to affect the user from holding the handle and cause the light emitted by the light-emitting unit to be too diffuse, the radial width 631 of the light-transmitting area 611 is less than 3 mm.

For instance, the radial width 631 of the light-transmitting area 611 on the handle is 2 mm, 2.5 mm, etc., which is not limited thereto.

Optionally, as shown in FIG. 6A, a maximum distance 632 of the light-transmitting area 611 along the circumferential direction of the handle is greater than 14 mm, thereby ensuring that the light-transmitting area has a display range that is easy to be observed and improving the visibility of the oral care device.

Optionally, to avoid a distance between each adjacent light-emitting units 621 being too large, which would result in relatively dim light in a center thereof and uneven brightness, the distance between each two adjacent light-emitting units 621 is less than 5 mm.

Optionally, as shown in FIG. 6A, the handle comprises a button 614. Both the button 614 and the light-transmitting area 611 are circular, and the button 614 and the light-transmitting area 611 are disposed at intervals along the axial direction of the handle. A difference between a diameter of the button 614 and a diameter of the light-transmitting area 611 is within ±2 mm, which allows the user to easily observe the information transmitted by the light-transmitting area when performing oral care through the oral care device and improves the operability, visibility, and esthetics of the oral care device.

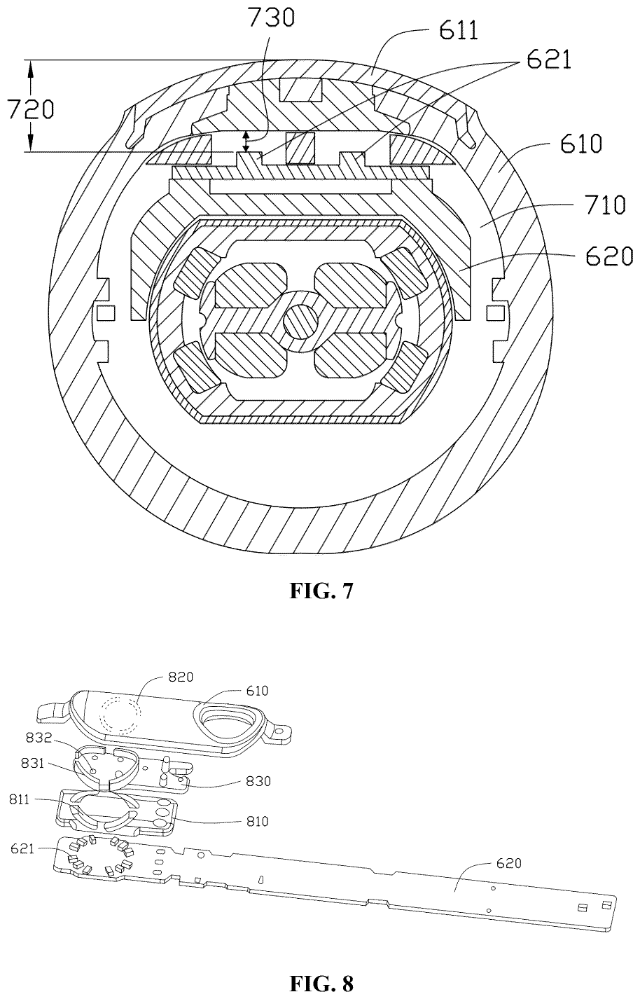

In some optional embodiments, as shown in FIG. 7, the housing 610 has an accommodating cavity 710, and the power component 620 is installed in the accommodating cavity 710. In an orthographic projection of the light-emitting units 621 onto the light-transmitting area 611, in order to ensure that the light emitted by the light-emitting units 621 is able to completely pass through the light-transmitting area 611, outer contours of the light-emitting units 621 are located within an outer contour of the light-transmitting area 611. To avoid a problem that the light being unable to be emitted over a long distance due to a distance between the light-emitting units and the handle being too close, and to avoid a blurry and uneven light source, the distance 720 between any one of outer surfaces of the light-emitting units 621 and the outer surface of the light-transmitting area 611 is greater than 2.5 mm. Therefore, it is ensured that the light emitted by the light-emitting units is transmitted over a certain distance, which solves a problem of local bright spots and blurry and uneven light source caused by the light-emitting units 621 being too close, thereby improving the visibility of the oral care device.

In some optional embodiments, as shown in FIG. 7, to avoid a problem of bright spots easily occurring due to a small gap 730 between any one of the outer surfaces of the light-emitting units 621 and an inner surface of the housing 610, the gap 730 between any one of the outer surfaces of the light-emitting unit 621 and the inner surface of the housing 610 is greater than 0.8 mm. Further, to avoid a problem of dim light and poor display effect caused by a large gap 730 between any one of the outer surfaces of the light-emitting units 621 and the inner surface of the housing 610, the gap 730 between any one of the outer surfaces of the light-emitting units 621 and the inner surface of the housing 610 is less than 2 mm, so that it is easy for the user to observe the information displayed in the light-transmitting area 611.

For instance, the gap 730 between the surface of the light-emitting unit 621 and the inner surface of the housing 610 is 1 mm, 1.5 mm, etc., which is not limited thereto.

In some optional embodiments, a cross section of the light-emitting units 621 is taken along a plane perpendicular to an axis of the power component 620. A ratio of A length of a line connecting two light-emitting units 621 having a maximum spacing therebetween to a diameter of the housing 610 is 1:3-5:6. The diameter of the housing 610 is, for example, but not limited to, an inner diameter or an outer diameter of the housing 610. In this way, it is avoided that a light-emitting range corresponding to the light-emitting units 621 is too small for the user to observe, and it is further avoided that the light-emitting range corresponding to the light-emitting units 621 is too large to be far from the outer surface of the light-transmitting area 611, thereby further avoiding uneven brightness, loss of light intensity, and easy generation of bright spots.

In some optional embodiments, as shown in FIG. 8, the power component 620 further comprises a light-shielding piece 810. The light-shielding piece 810 defines light-shielding grooves 811. The light-emitting units 621 are disposed within the light-shielding grooves 811, and the outer surfaces of the light-emitting units 621 do not extend out of the light-shielding grooves 811. Inner walls of the light-shielding grooves 811 are spaced apart from the light-emitting units 621, thereby allowing the light emitted by the light-emitting units 621 to be scattered without being blocked, ensuring that the light-emitting units 621 form a uniform brightness display in the light-transmitting area.

In some optional embodiments, as shown in FIG. 8, the handle defines light-transmitting holes 820. The light-transmitting holes 820 are disposed correspondingly to the light-transmitting area. A light guide piece 830 is disposed on the inner wall of the housing 610, and the light guide piece 831 extends into the light-transmitting hole 820. In this way, the light emitted by the light-emitting units 621 is transmitted through the light guide piece 830. The light guide piece 830 plays a role in uniform light distribution, so as to ensure the uniformity of the brightness of the display content in the light-transmitting area, where the display content is formed by the light emitted by the light-emitting units 621. Therefore, the generation of bright spots is avoided, and the visibility of the oral care device is improved.

Optionally, as shown in FIG. 8, the handle defines the light-transmitting holes 820. The light-transmitting holes 820 are arc-shaped and spaced apart in a circle around the handle. The light-emitting units 621 are disposed corresponding to the light-transmitting holes 820. That is, the light-transmitting holes 820 are one-to-one corresponding to the light-emitting units 621. In this way, each two adjacent light-transmitting holes are spaced apart to prevent light leakage.

Furthermore, to avoid light leakage (for example, when one of the light-transmitting holes emits red light and an adjacent one of the light-transmitting holes emits white light), and to reduce mutual influence between the two adjacent light-transmitting holes, the distance between each two adjacent light-transmitting holes is greater than 1.2 mm.

Optionally, the housing 610 comprises protruding columns extending inward. As shown in FIG. 8, the light guide piece 830 defines through holes 832, and the protruding columns on the housing 610 extend into the through holes 832. The light guide piece 830 and the housing 610 are integrally formed, thereby improving stability of a connection between the housing 610 and the light guide 830.

Furthermore, to further enhance the stability of the connection between the housing 610 and the light guide piece 830, a cross-sectional area of an end portion of each of the protruding columns on the housing 610 is greater than a cross-sectional area of a middle portion of each of the protruding columns, and a shape of each of the through holes is matched with a shape of each of the protruding columns.

In some optional embodiments, as shown in FIG. 6A, a light-transmitting shell 613 is disposed on the outer surface of the housing 610. The light-transmitting shell 613 covers the outer surface of the housing 610, and an outer surface of the light-transmitting shell 610 is a frosted surface or a glossy surface. The light-transmitting area 611 is disposed in the light-transmitting shell 613. Thus, the light transmission of the light-transmitting area is relatively blurred through the frosted surface of the light-transmitting shell, which realizes an effect of blurring bright spots. Alternatively, the glossy surface of the light-transmitting shell makes the display of the light-transmitting area clearer and easier for the user to observe.

Furthermore, to ensure the light-transmitting area 611 has a large area and make the information displayed in the light-transmitting area 611 easier for the user to observe, as shown in FIG. 6A, a distance 640 between an outer edge of the light-transmitting area 611 and an edge of the light-transmitting shell 613 is less than 3 mm.

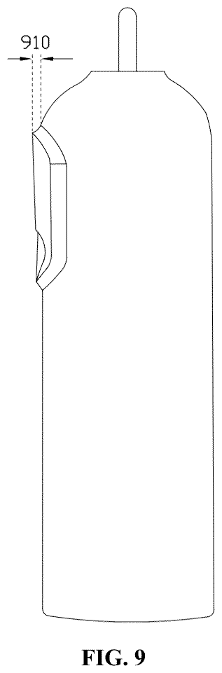

In some optional embodiments, as shown in FIG. 9, to ensure that the light emitted by the light-emitting units is transmitted over a certain distance, to solve a problem of shadow formed between each two adjacent light-emitting units due to excessively small distance therebetween, and to ensure light uniformity of the light in the light-transmitting area, the light-transmitting area 611 protrudes relative to the holding portion of the handle, and a protruding height 910 of the light-transmitting area 611 is 0.5-3 mm, such as, 0.8 mm, 1 mm, etc., which is not limited thereto.

Furthermore, to further solve a problem of the shadow formed between each two adjacent light-emitting units due to excessively small distance therebetween, and to further improve the light uniformity of the light in the light-transmitting area, the protruding height 910 of the light-transmitting area 611 is 0.8-1.5 mm.

Optionally, as shown in FIG. 6A, the handle further comprises a button 614, and the outer surface of the housing 610 comprises a transparent sheet 615. The transparent sheet 615 surrounds an outer periphery of the button 614. The protruding height of the light-transmitting area 611 is 0.8 mm and the light-transmitting area 611 has a volcano-like shape to raise the button 614 and the transparent sheet 615. In this way, a functional area of the oral care device is made obvious to facilitate operation and use of the oral care device.

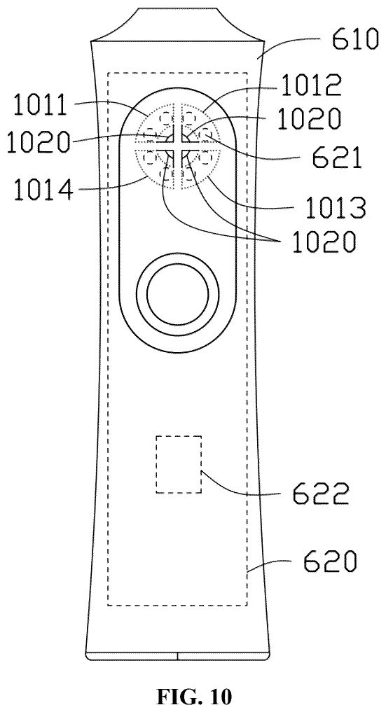

In some optional embodiments, as shown in FIG. 10, the light-transmitting area 611 comprises light-transmitting sub-areas, such as, but not limited to light-transmitting sub-areas (1011, 1012, 1013, 1014), etc. The light-transmitting sub-areas (1011, 1012, 1013, 1014) are spaced apart in a ring shape along the circumferential direction of the handle. By providing the light-transmitting sub-areas spaced apart from each other, interference between each two adjacent light-transmitting sub-areas is reduced when the light-transmitting sub-areas emit light, thereby alleviating light crosstalk between the light-transmitting sub-areas.

Optionally, to make the information displayed by the light emitted by the light-emitting units 621 easy to observe, a sum of central angles corresponding to the light-transmitting area 611 (e.g., but not limited to, a sum of the central angles 1020 respectively corresponding to the light-transmitting sub-areas (1011, 1012, 1013,1014) shown in FIG. 10) is greater than 180 degrees. Therefore, the light emitted by the light-emitting units 621l has a large display range to enhance the visibility during the use of the oral care device.

In some optional embodiments, the light-emitting units 621 are disposed at intervals. As shown in FIG. 6A, the light-emitting units 621 are corresponding to the light-transmitting area 611. Alternatively, as shown in FIG. 10, the light-transmitting area 611 comprises the light-transmitting sub-areas, each of the light-transmitting sub-areas is corresponding to one or more of the light-emitting units 621. In this way, the problem of the shadow formed between each two adjacent light-emitting units due to excessively small distance therebetween is solved, and the light uniformity of the light in the light-transmitting area is ensured.

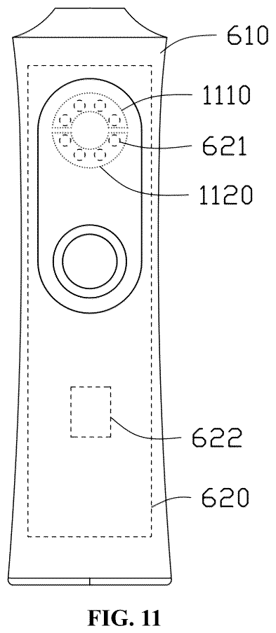

In some optional embodiments, as shown in FIG. 11, the light-transmitting area comprises an upper light-transmitting sub-area 1110 and a lower light-transmitting sub-area 1120. The upper light-transmitting sub-area 1110 corresponds to the upper teeth area, and the lower light-transmitting sub-area 1120 corresponds to the lower teeth area. By distributing the upper light-transmitting sub-area 1110 and the lower light-transmitting sub-area 1120 according to the distribution of the upper teeth area and the lower teeth area, the user is able to intuitively and accurately understand the information of the corresponding upper teeth area and the lower teeth area and develop the correct oral care habits. Further, the user, especially the kid, is prevented from being careless when performing oral care.

Optionally, as shown in FIG. 10, the upper light-transmitting sub-area on the handle further comprises an upper left light-transmitting sub-area 1011 and an upper right light-transmitting sub-area 1012, and the lower light-transmitting sub-area further comprises a lower left light-transmitting sub-area 1014 and a lower right light-transmitting sub-area 1013. one of the oral care positions displayed by upper left light-transmitting sub-area 1011 corresponds to the upper left teeth area, one of the oral care positions displayed by the upper right light-transmitting sub-area 1012 corresponds to the upper right teeth area, one of the oral care positions displayed by the lower left light-transmitting sub-area 1014 corresponds to the lower left teeth area, and one of the oral care positions displayed by the lower right light-transmitting sub-area 1013 corresponds to the lower right teeth area. The upper left light-transmitting sub-area 1011, upper right light-transmitting sub-area 1012, lower left light-transmitting sub-area 1014, and lower right light-transmitting sub-area 1013 are distributed according to the distribution of the upper left teeth area, the upper right teeth area, the lower left teeth area, and the lower right teeth area, which makes the oral care positions displayed in the light-transmitting sub-areas more closely match an actual oral condition of the oral cavity of the user, so that the user is allowed to intuitively and accurately observe the information of the upper left teeth area, the upper right teeth area, the lower left teeth area, and the lower right teeth area. As a result, the user is able to develop correct oral care habits, and the user, especially the kid, is prevented from being careless when performing oral care.

Optionally, the upper light-transmitting sub-area on the handle further comprises an upper left light-transmitting sub-area, an upper middle light-transmitting sub-area, and an upper right light-transmitting sub-area. The lower light-transmitting sub-area may comprise a lower left light-transmitting sub-area, a lower middle light-transmitting sub-area, and a lower right light-transmitting sub-area. The upper left light-transmitting sub-area corresponds to an upper left teeth area, the upper middle light-transmitting sub-area corresponds to an upper middle teeth area, the upper right light-transmitting sub-area corresponds to an upper right teeth area, the lower left light-transmitting sub-area corresponds to a lower left teeth area, the lower middle light-transmitting sub-area corresponds to a lower middle teeth area, and the lower right light-transmitting sub-area corresponds to a lower right teeth area. By distributing the light-transmitting sub-areas according to the distribution of the teeth areas, the oral care positions respectively displayed by the light-transmitting sub-areas are made more closely aligned with the actual oral condition of the user, so that the user is allowed to intuitively, accurately, and meticulously understand the oral care information of the upper left teeth area, upper middle teeth area, the upper right teeth area, the lower left teeth area, the lower middle teeth area, and the lower right teeth area. The user, especially the kid, is guided to efficiently and accurately develop the correct oral care habits, so that the user is no longer careless when performing oral care.

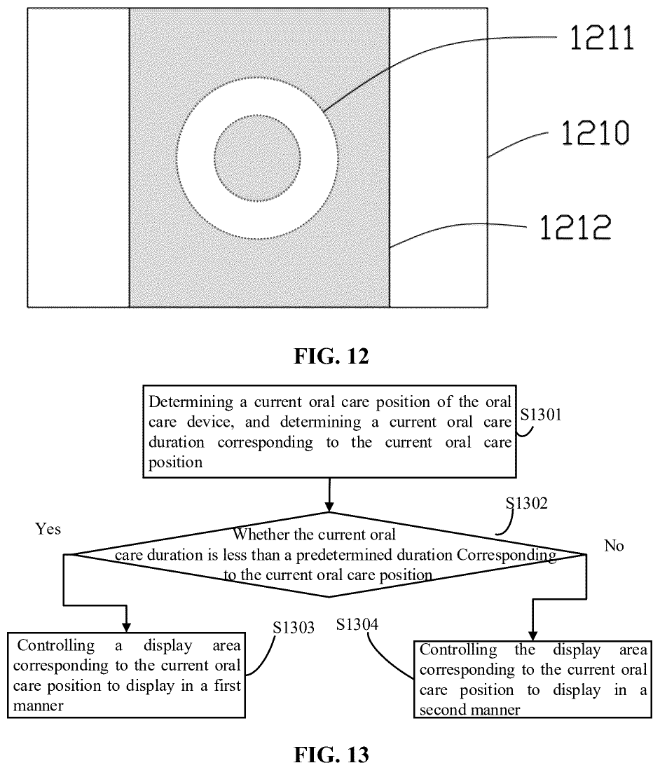

In some optional embodiments, as shown in FIG. 12, in a projection plane 1210 perpendicular to a central axis of the light-transmitting area 611, the distance between the outer edge 1211 of the light-transmitting area 611 and an outer edge 1212 of the housing 610 along the width direction is less than 4 mm, thereby giving the light-transmitting area 611 a large area and making the information displayed in the light-transmitting area 611 easy for the user to observe.

Optionally, the handle may be, but is not limited to, applied to the oral care device (e.g., the electric toothbrushes). That is, the oral care device comprises the handle and a care element (i.e., the brush head). The care element is connected to the handle to operate under the action of the handle. The handle may be a brush handle, and the care element may be a brush head connected to the brush handle and is detachable by hand.

Based on FIGS. 1-12, an information display method of an oral care device is provided in one exemplary embodiment of the present disclosure. Specifically, as shown in FIG. 13, FIG. 13 is a flow chart of an information display method of the oral care device according to one embodiment of the present disclosure. The information display method comprises steps S1301-1301.

The step S1301 comprises determining a current oral care position of the oral care device, and determining a current oral care duration corresponding to the current oral care position.

Specifically, the oral care device has an oral care position recognition function. During an oral care process, the oral care device is able to identify the current oral care position by a positioning component, such as by a multi-axis sensor or a camera. The oral care device is further configured to calculate the current oral care duration corresponding to the current oral care position. The current oral care duration may be, but is not limited to, a time length of the oral care device remains at the current oral care position.

Furthermore, during determining the current oral care duration corresponding to the current oral care position, when a dwell duration of the oral care device at a third oral care position exceeds a third target duration, the third oral care position is determined as the current oral care position. The third target duration may be, but is not limited to, 0.8 s, 1 s, etc. Thus, only when the dwell duration of the oral care device at the third oral care position exceeds the third target duration, a current timing is considered valid, and the oral care device is determined to perform oral care on the third oral care position. When the oral care device moves to another oral care position before the dwell duration at the third oral care position does not exceed the third target duration, the current timing is considered invalid, and the oral care device is merely performing a rolling motion, which avoids a problem of misidentification of the current oral care position caused by rolling of the oral care device during the switching of the oral care positions. Further, it makes the calculation of the oral care duration of the oral care positions more accurate, resulting in a more accurate and reasonable presentation of oral care results.

The step S1302 comprises determining whether the current oral care duration is less than a predetermined duration corresponding to the current oral care position.

Specifically, the predetermined duration corresponding to the current oral care position may be, but is not limited to, an oral care duration required to achieve a desired oral care effect at the current oral care position. The predetermined duration of each of the oral care positions may be different or the same, which is determined according to actual conditions; which is not limited thereto.

For instance, the oral care device comprises four display areas, which are respectively corresponding to four oral care positions. The four oral care positions are an upper left teeth area, an upper right teeth area, a lower left teeth area, and a lower right teeth area. The predetermined duration of each of the oral care positions may be, but is not limited to, 30 seconds, 25 seconds, etc.

The step S1303 comprises when the current oral care duration is less than the predetermined duration corresponding to the current oral care position, controlling a display area corresponding to the current oral care position to display in a first manner.

Specifically, when the current oral care duration corresponding to the current oral care position is less than the predetermined duration corresponding to the current oral care position, it is considered that the current oral care duration is insufficient and there is a risk of tooth decay. When an oral care effect corresponding to the current oral care position is not up to standard, the display area corresponding to the current oral care position is controlled to display in the first manner, thereby notifying the user that the current oral care position does not meet the standards and the oral care at the current oral care position needs to be strengthened.

The step S1304 comprises when the current oral care duration is not less than the predetermined duration corresponding to the current oral care position, controlling the display area corresponding to the current oral care position to display in a second manner.

Specifically, when the current oral care duration corresponding to the current oral care position is not less than the predetermined duration corresponding to the current oral care position, it is considered that the current oral care duration at the current oral care position is sufficient, there is no risk of tooth decay at the current oral care position, and the oral care effect corresponding to the current oral care position meets the standard. Then, the display area corresponding to the current oral care position is controlled to display in the second manner. A display effect of the first manner is different from a display effect of the second manner, thereby notifying the user that the current oral care position meets the standard and the user is encouraged to switch to a next oral care position for oral care. In this way, the oral care efficiency of the user is improved to a certain extent.

The four-factor theory posits that main causes of tooth decay in children are: bacteria (Streptococcus mutans, Porphyromonas gingivalis)+oral environment (food & saliva)+host (teeth, saliva quality and flow rate, overall health)+time. These four factors are the main causes of tooth decay in children; an absence of any one of the four factors would not cause tooth decay. Cariogenic sugars (especially sucrose and refined carbohydrates) adhere tightly to a tooth surface, forming an acquired membrane from salivary proteins. The acquired membrane not only adheres firmly to the tooth surface but also, under suitable temperatures and with sufficient time, produces acid deep within the plaque, attacking the teeth, demineralizing the teeth, and ultimately destroying organic matter, leading to tooth cavities.

Therefore, in the embodiment, in one or more embodiments of the present disclosure, the current oral care position of the oral care device is determined, and the current oral care duration corresponding to the current oral care position is determined, and when the current oral care duration is less than the predetermined duration corresponding to the current oral care position, a display area corresponding to the current oral care position is controlled to display in the first manner. Alternatively, when the current oral care duration is not less than the predetermined duration corresponding to the current oral care position, a display area corresponding to the current oral care position is controlled to display in the second manner. The display effect of the first manner is different from the display effect of the second manner. The user is notified whether the current oral care position is properly cared for through different display effects of the display area corresponding to the current oral care position, so that the user is encouraged to complete sufficient oral care duration at the current oral care position, which reduces plaque at the corresponding oral care position and prevents bacteria, oral environment, and host from meeting time requirements for caries to occur, thus reducing the risk of caries to a certain extent. Furthermore, the display effects of the display areas corresponding to the oral care positions further stimulate the interest of the user in oral care, guide the user to care for sufficient time, clean each of the oral care positions, and guide the user to develop the correct oral care habits. Therefore, the user, especially the kid, is no longer careless in oral care.

In some optional embodiments, when an oral care duration of any one of non-current oral care positions is 0, a display area corresponding to the one of the non-current oral care positions is always displayed in a third manner. A display effect of the third manner is different from the display effect of the first manner and the display effect of the second manner. Therefore, by displaying different display effects at the non-current oral care positions than the display effect of the current oral care position, the user is reminded that which oral care positions have not yet been cared for, thus preventing the user from overlooking certain oral care positions and increasing the probability of cavities in the oral care positions. Therefore, the risk of cavities is reduced to some extent and the user is able to develop the correct oral care habits.

It is understood that the third manner is equivalent to an initial display manner of each of the display areas corresponding to the non-current oral care positions before oral care is performed.

In some optional embodiments, when an oral care duration of any one of non-current oral care positions is greater than 0 and less than a predetermined duration corresponding to the one of the non-current oral care positions, it is determined that the one of the non-current oral care positions has been cared for, but not for a sufficient duration, and a corresponding oral care effect is not up to standard. A display area corresponding to the one of the non-current oral care positions is always displayed in the third manner. The display effect of the third manner is different from the display effect of the first manner and the display effect of the second manner, thereby reminding the user that the one of the oral care positions has not been properly cared for and needs to be further cared for. In this way, the user is prevented from missing any one of the oral care positions that has been cared for but not properly cared for during oral care. Therefore, the user is able to develop the correct oral care habits, and reduces the risk of tooth decay.

In some optional embodiments, when the oral care duration of any one of the oral care positions is greater than a predetermined duration corresponding to the one of the oral care positions, it is determined that the one of the current oral care positions has been cared for a sufficient duration. Regardless of whether the one of the oral care positions is the current oral care position, the oral care effect corresponding to the one of the oral care positions has been achieved. In this case, the display area corresponding to the one of the oral care positions is always be displayed in the second manner, thereby notifying the user that the one of the oral care positions has been properly cared for and there is no need to strengthen the care of the one of the oral care positions, which avoids situations where the user forgets or is unaware that the one of the oral care positions has been properly cared for and repeats oral care, thereby improving the efficiency and oral care experience of the user when using the oral care device.

For instance, when the oral care device has not performed oral care on the upper teeth area (i.e., one of the oral care positions), the display area corresponding to the upper teeth area is always displayed in the third manner. When the oral care device detects that the oral care is currently performed on the upper teeth area (the current oral care position), the display area corresponding to the upper teeth area switches from the third manner to the first manner. When the current oral care duration corresponding to the upper teeth area (i.e., the current oral care position) is not less than the predetermined duration corresponding to the current oral care position, the display area corresponding to the upper teeth area (i.e., the current oral care position) switches from the first manner to the second manner. When the oral care duration corresponding to the upper teeth area is not less than the predetermined duration corresponding to the upper teeth area, regardless of whether the oral care device is currently performing oral care on the upper teeth area, the display area corresponding to the upper teeth area is always displayed in the second manner. Thus, by switching different display effects of the display area corresponding to the one of the oral care positions, the user is reminded to observe the changes in the oral care state of the one of the oral care positions, making it easy for the user to intuitively observe the oral care state of each of the oral care positions and improving the user experience of using the oral care device for oral care.

In some optional embodiments, the first manner may comprise, but is not limited to, displaying in a flashing light. The second manner may comprise, but is not limited to, displaying in first color. The third manner comprises displaying in a second color. The flashing light display may comprise, but is not limited to, at least one of the following modes: alternating flashing with the first color and the second color; a first light-emitting unit in the display area corresponding to the one of the oral care positions remaining constantly lit with the first color; and a second light-emitting unit thereof flashing with the second color, flashing with the first color, and flashing with the second color, etc. The first color is different from the second color. The first color may be, but is not limited to, white, etc., indicating that the one of the oral care positions corresponding to the display area has been properly cared for. The second color may be, but is not limited to, pink, red, etc., indicating that the one of the oral care positions corresponding to the display area has not been properly cared for. Thus, each of the display areas is able to display different colors to notify the user whether each of the oral care positions is properly cared for, and the flashing light display allows the user to intuitively and efficiently observe the oral care position currently being cared for, thereby further increasing the visibility during the use of the oral care device.

It is understood that each of the display areas comprises corresponding light-emitting units. When the first light-emitting unit of any display area is constantly lit with the first color and the second light-emitting unit thereof flashes with the second color, the first light-emitting unit and the second light-emitting unit are disposed at intervals, which is not limited thereto. That is, when any display area displays, the two light-emitting units disposed at different positions respectively corresponding to two different display modes, so that each of the display areas is able to display significantly different display effects.

Optionally, the display effect of the third manner is the same as the display effect of the first manner, which is not limited thereto.

For instance, during oral care, when the user has not yet started oral care, that is, the oral care duration of each of the care positions is 0, and each of the display areas is controlled to display in solid red (third manner). When the user starts oral care, that is, when the oral care device detects that there is the current oral care position being cared for, and the oral care duration corresponding to the current oral care position does not reach the predetermined duration (e.g., 30 seconds) corresponding to the current oral care position, it indicates that the oral care duration for the current oral care position does not reach the standard. During the oral care, when the current oral care position does not reach the standard, the display area corresponding to the current oral care position is controlled to switch from solid red (i.e., the third manner) to flashing red (i.e., the first manner) to remind the user of the current oral care position and to inform the user that the current oral care position does not meet the standard. Once the oral care duration corresponding to the current oral care position reaches the predetermined duration corresponding to the current oral care duration, it indicates that the care for the current oral care position meets the standard, and the display area corresponding to the current oral care position is switched from flashing red (first manner) to solid white (second manner). During the process, even if the oral care duration for the current oral care position continues to increase, that is, the current oral care duration is greater than the predetermined duration corresponding to the current duration, the display area corresponding to the current duration still displays solid white to inform the user that the current oral care position meets the standard and no further care is needed. When the oral care device detects that an oral care duration of a previous oral care position has not yet reached a predetermined duration corresponding to the previous oral care position before switching to the current oral care position that has not yet been cared for or has not yet met the standards, the display area corresponding to the previous oral care position is controlled to switch from flashing red (first manner) to solid red (third manner) to inform the user that the previous oral care position has not yet met the standards and oral care needs to continue. At the same time, the oral care device further controls the display area corresponding to the current oral care position to switched from solid red (third manner) to flashing red (first manner) to inform the user the current oral care position is currently cared for.

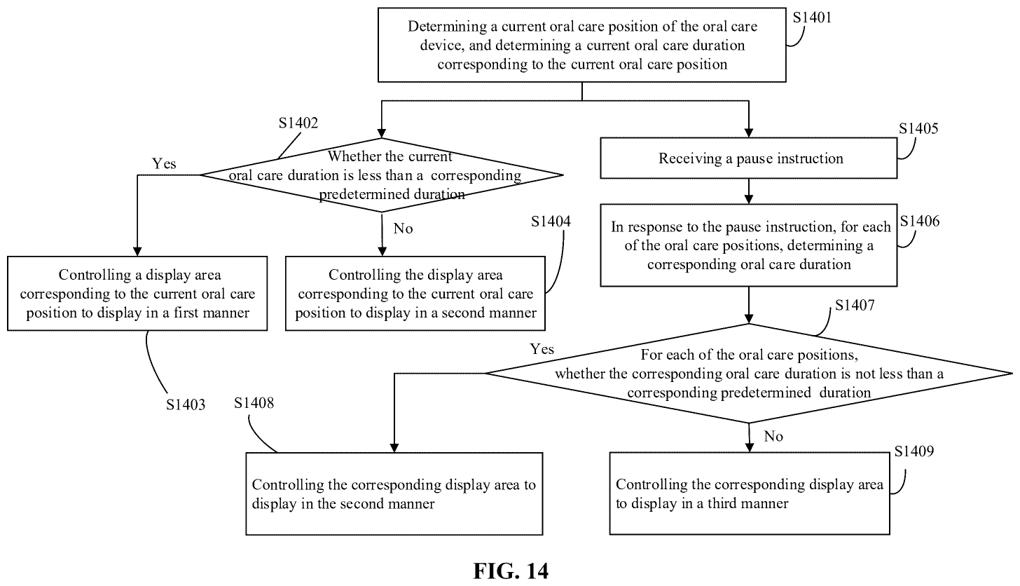

FIG. 14 is another flow chart of the information display method of the oral care device according to one embodiment of the present disclosure. As shown in FIG. 14, the information display method comprises steps S1401-S1409.

The step S1401 comprises determining a current oral care position of the oral care device, and determining a current oral care duration corresponding to the current oral care position.

Specifically, the step S1401 is the same as the step S1301, which is not described in detail herein.

The step S1402 comprises determining whether the current oral care duration is less than a predetermined duration corresponding to the current oral care position.

Specifically, the step S1402 is the same as the step S1302, which is not described in detail herein.

The step S1403 comprises when the current oral care duration is less than the predetermined duration corresponding to the current oral care position, controlling a display area corresponding to the current oral care position to display in a first manner.

Specifically, the step S1403 is the same as the step S1303, which is not described in detail herein.

The step S1404 comprises when the current oral care duration is not less than the predetermined duration corresponding to the current oral care position, controlling the display area corresponding to the current oral care position to display in a second manner.

Specifically, the step S1404 is the same as the step S1304, which is not described in detail herein.

The step S1405 comprises receiving a pause instruction.

Specifically, during oral care, when the user wants to pause the oral care process, the user is able to trigger the pause instruction by pressing the button or controlling a posture of the oral care device, so as to pause a current oral care task.

Optionally, during oral care, the oral care device is further able to receive the pause instruction from another device communicated with the oral care device via a network, which is not limited thereto.

It is understood that the step S1405 may be executed after the step S1401, which means that the oral care device may receive the pause instruction after determining the current oral care position. Alternatively, the step S1405 and the step S1401 may be executed simultaneously, which means that the oral care device may receive the pause instruction while determining the current oral care position, which is not limited thereto. To reduce power consumption of the oral care device, the oral care device is able to pause an execution of the step S1401 upon receiving the pause instruction, i.e., paused an oral care position recognition function, thereby avoiding wasted power due to invalid oral care position recognition.

The step S1406 comprises in response to the pause instruction, for each of the oral care positions, determining a corresponding oral care duration.

Specifically, after receiving the pause instruction, the oral care device responds to the pause instruction and determines the corresponding oral care duration of each of the oral care positions.

The step S1407 comprises for each of the oral care positions, determining whether the corresponding oral care duration is not less than a predetermined duration thereof.

Specifically, the predetermined duration of the oral care positions may be the same or different. For instance, in order to ensure the oral care effect of each of the oral care positions, different predetermined duration is determined according to difficulty of achieving the oral care standard for different oral care positions, which are not limited thereto.

The step S1408 comprises, if yes, for each of the oral care positions, controlling a corresponding display area to display in the second manner.

Specifically, when the oral care duration corresponding to one of the oral care positions is not less than the predetermined duration corresponding to the one of the oral care positions, it is considered that the oral care duration of the one of the oral care positions has met the standard. Then, the display area corresponding to the one of the oral care positions is controlled to display in the second manner to remind the user that the one of the oral care positions has been properly cared for.

The step S1409 comprises if no, for each of the oral care positions, controlling the corresponding display areas to display in a third manner.

Specifically, the display effect of the third manner is different from the display effect of the first manner and the display effect of the second manner. When the oral care duration corresponding to the one of the oral care positions is less than the predetermined duration corresponding to the one of the oral care positions, it is considered that the oral care duration of the one of the oral care positions has not met the standard. In this case, the display area corresponding to the one of the oral care positions is controlled to display in the third manner to remind the user that one of the oral care positions has not been properly cared for and that more care needs to be given to the one of the oral care positions.

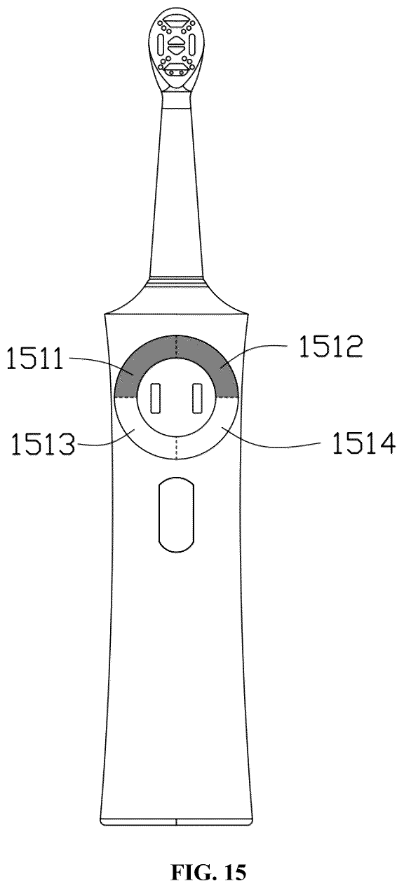

For example, as shown in FIG. 15, the oral care device comprises four display areas: which are respectively a display area 1511, a display area 1512, a display area 1513, and a display area 1514. The four display areas respectively correspond to four oral care positions, which are respectively the upper left teeth area, the upper right teeth area, the lower left teeth area, and the lower right teeth area. When the user presses the button on the oral care device for pausing, and when the oral care duration of the upper left teeth area and the oral care duration of the oral care duration of the upper right teeth area are respectively less than the predetermined duration of the upper left teeth area and the predetermined duration of the upper right teeth area (i.e., the oral care duration of the upper left teeth area and the oral care duration of the upper right teeth area do not meet the standard), while the oral care duration of the lower left teeth area and the oral care duration of the lower right teeth area are respectively not less than the predetermined duration of the lower left teeth area and the predetermined duration of the lower right teeth area (i.e., the oral care duration of the lower left teeth area and the oral care duration of the lower right teeth area meet the standard), then the display area 1513 and the display area 1514 are controlled to display in first color, and the display area 1511 and the display area 1512 are controlled to display in a second color different from the first color. That is, after the user pauses oral care, as shown in FIG. 15, display effects of the display area 1513 and the display area 1514 corresponding to the lower left teeth area and the lower right teeth area are different from display effects of the display areas 1511 and 1511 corresponding to the upper left teeth area and upper right teeth area.

In the embodiment, after the oral care device receives the pause instruction, such as when the user presses the button on the oral care device to trigger the pause instruction, the display areas corresponding to the oral care positions where the corresponding oral care duration has been reached the standard are displayed in the second manner, such as, but not limited to, displayed in the first color. The display areas corresponding to the oral care positions where the corresponding oral care duration has not reached the standard are displayed in the third manner, such as, but not limited to, displayed in the second color. The second color is different from the first color. Thus, after the user pauses oral care, different display effects indicate to the user which oral care positions have reached the standard and which oral care positions have not reached the standard. In this way, the user is allowed to fully and intuitively understand the oral care state of each of the oral care positions when pausing the oral care operation. The display effects provide an intuitive reference and reminder for the user on whether oral care needs to continue or at which oral care positions, thereby further improving the oral care efficiency and oral care experience.

Optionally, in the S1408, for each of the oral care positions, the controlling the corresponding display area to display in the second manner comprises, but is not limited to: when the oral care device is not triggered within a first duration after receiving the pause instruction, determining that the user did not operate the oral care device after pausing oral care and the user may not continue oral care at this time. Therefore, for each of the oral care positions, the corresponding display area is controlled to light up in a first color for a second duration, then the corresponding display area is flashed for a third duration, and the corresponding display area is turned off. Therefore, after the user pauses the oral care, the user is reminded that the oral care duration of any one of the oral positions has reached the standard by displaying in the first color for the second duration in the corresponding display area, and the user is further reminded that the oral care device is about to be turned off, enter a standby mode, or after the corresponding display area displays the first color for the second duration, the user is reminded that the corresponding display area is about to turn off by flashing in the first color for the third duration. Furthermore, when the oral care device is not triggered after flashing in the first color for the third duration, it is determined that the user may not continue oral care, and the display areas are automatically turned off to reduce power loss of the oral care device.

In the step S1409, for each of the oral care positions, the controlling the corresponding display areas to display in the third manner comprises, but is not limited to: when the oral treatment device is not triggered within the first duration after receiving the pause instruction, determining that the user did not operate the oral care device after pausing oral care and the user may not continue oral care at this time, controlling the corresponding display area to display with a solid light in a second color for the second duration, then flashing the corresponding display area for the third duration, and turning off the corresponding display area;

The first color is different from the second color. The first color may be, but is not limited to, white, etc., indicating that the oral care duration of each of the oral care positions corresponding to the display areas reaches the standard. The second color may be, but is not limited to, pink, red, etc., indicating that the oral care duration of each of the oral care positions corresponding to the display areas does not reach the standard. Thus, after the user pauses the oral care operation, the display area of each of the oral care positions first light up with the second color different from the first color to indicate that the oral care duration of each of the oral care positions has not reached the standard. Then, after the second color is lit up for the second duration, each of the display areas corresponding to each of the oral care positions flashes in the second color to indicate that the oral care device is about to be turned off, enter the standby mode, or that each of the display areas is about to turn off. Furthermore, when the oral care device is not triggered after each of the display areas flashes in the second color for the third time, it is determined that the user may not continue oral care, the display areas are automatically turn off to reduce the power loss of the oral care device. The first duration is equal to a sum of the second duration and the third duration. The first duration may be, but is not limited to, 20 s, 30 s, etc. The second duration may be, but is not limited to, 15 s, 20 s, etc. The third duration may be, but is not limited to, 5 s, 10 s, etc.

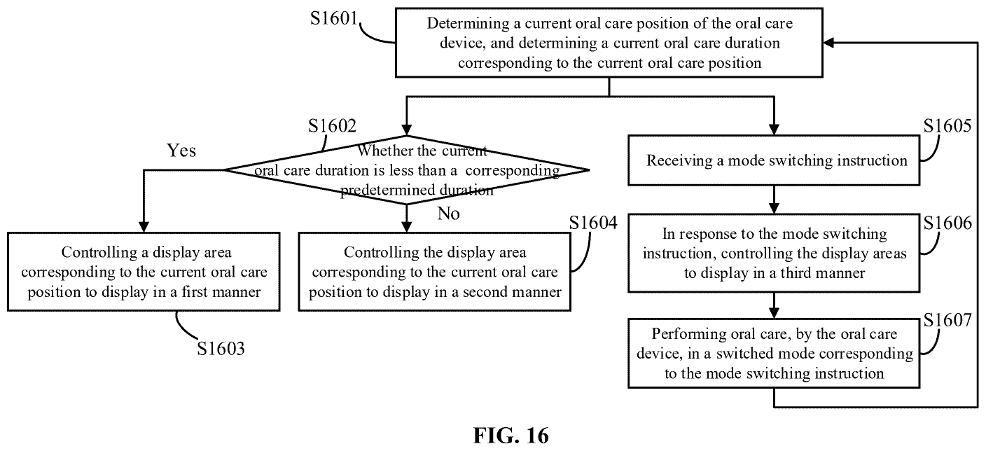

FIG. 16 is another flow chart of the information display method of the oral care device according to one embodiment of the present disclosure. As shown in FIG. 16, the information display method comprises steps S1601-S1607 The step S1601 comprises determining a current oral care position of the oral care device, and determining a current oral care duration corresponding to the current oral care position.

Specifically, the step S1601 is the same as the step S1301, which is not described in detail herein.

The step S1602 comprises determining whether the current oral care duration is less than a predetermined duration corresponding to the current oral care position.

Specifically, the step S1602 is the same as the step S1302, which is not described in detail herein.

The step S1603 comprises when the current oral care duration is less than the predetermined duration corresponding to the current oral care position, controlling a display area corresponding to the current oral care position to display in a first manner.

Specifically, the step S1603 is the same as the step S1303, which is not described in detail herein.

The step S1604 comprises when the current oral care duration is not less than the predetermined duration corresponding to the current oral care position, controlling the display area corresponding to the current oral care position to display in a second manner.

Specifically, the step S1604 is the same as the step S1304, which is not described in detail herein.

The step S1605 comprises receiving a mode switching instruction.

Specifically, during oral care, when the user wants to switch modes using the oral care device, the user may, but not limited to, trigger the mode switching instruction through a button or other means, thereby causing the oral care device to switch to a corresponding mode.

Optionally, during oral care, the oral care device may receive the mode switching instruction from another device communicated with the oral care device via a network, which is not limited thereto.

The step S1606 comprises in response to the mode switching instruction, controlling the display areas to display in a third manner.

Specifically, upon receiving the mode switching instruction, the oral care device determines that the user wants to restart a new round of oral care in a switched mode corresponding to the mode switching instruction. In response, the oral care device controls the display areas to display in the third manner, which is an initial display manner before the oral care positions are cared for. The display effect of the third manner is different from the display effect of the first manner and the display effect of the second manner.

The step S1607 comprises after the oral care device starts an oral care operation in a switched mode after the mode switching instruction is functioned, determining the current oral care position of the oral care device and determining the current oral care duration corresponding to the current oral care position.

Specifically, in response to the mode switching instruction, after controlling the display areas to return to initial display states and starting to perform oral care, by the oral care device in the switched mode corresponding to the mode switching instruction, the step S1601 is re-executed to determine the current oral care position of the oral care device and the current oral care duration corresponding to the current oral care position. That is, a new round of oral care position recognition and oral care duration statistics for each of the oral care positions are restarted. In this way, the effectiveness and accuracy of the oral care duration of the switched mode corresponding to the mode switching instruction are ensured, which avoids the oral care duration corresponding to a previous mode affecting the calculation of the oral care duration corresponding to the switched mode of the mode switching instruction, and ensures the oral care effects and display effects of the switched mode corresponding to the mode switching instruction after the oral care device undergoes a mode switch.

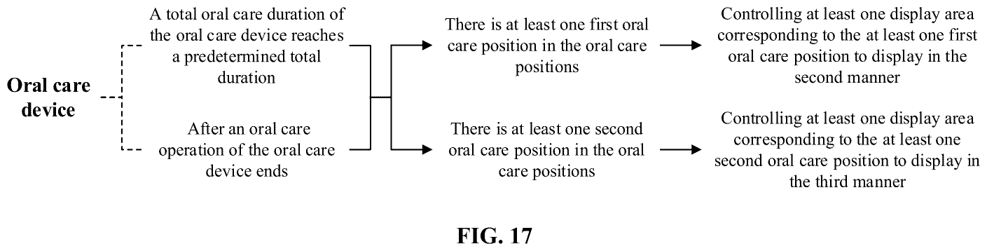

In some optional embodiments, as shown in FIG. 17, after a total oral care duration of the oral care device reaches a predetermined total duration or after an oral care operation of the oral care device ends, a motor of the oral care device stops working. At this time, when there is at least one first oral care position in the oral care positions, controlling at least one display area, corresponding to the at least one first oral care position, of the display areas, to display in the second manner, and when there is at least one second oral care position in the oral care positions, controlling at least one display area, corresponding to the at least second oral care position, of the display areas, to display in a third manner. The at least one first oral care position represents at least one of the oral care positions each having an oral care duration not less than a corresponding predetermined duration, and the at least one second oral care position represents at least one of the oral care positions each having an oral care duration less than a corresponding predetermined duration. The display effect of the third manner is different from the display effect of the second manner. Thus, after the oral care operation of the oral care device is completed, the display areas with different display effects remind the user the oral care duration of each of the oral care positions. That is, the display areas display the oral care result after the oral care is completed and notify the user of the oral care states after the oral care is completed. The predetermined total duration may be, but is not limited to, 3 minutes, 2 minutes, etc.

Optionally, after the total oral care duration of the oral care device reaches the predetermined total duration or after the oral care task is completed, the controlling the at least one display area corresponding to the at least one first oral care position to display in the second manner comprises: flashing the at least one display area corresponding to the at least one first oral care position in a first color for a fourth duration, and turning off the at least one display area corresponding to the at least one first oral care position. In this way, after oral care is completed, the user is notified that the at least one first oral care position has been properly cared for by the at least one display area corresponding to the at least one first oral care position flashing in the first color for the fourth duration, while the at least one display area corresponding to the at least one first oral care position is turned off to conserve power consumption of the oral care device after flashing for the fourth duration. The fourth duration may be, but is not limited to, 5 seconds, 3 seconds, etc., thus providing the user sufficient time to observe the information displayed in the at least one display area corresponding to the at least one first oral care position.

Optionally, after the total oral care duration of the oral care device reaches the predetermined total duration or after the oral care task is completed, the controlling the at least one display area corresponding to the at least second oral care position to display in a third manner comprises controlling the at least one display area corresponding to the at least one second oral care position to light up in the first color for a fifth duration, flashing the at least one display area corresponding to the at least one second oral care position for a sixth duration, and turning off the at least one display area corresponding to the at least one second oral care position. The first color is different from the second color. Thus, after the oral care is completed, the user is reminded that the at least one second oral care position has not been properly cared for through the at least one display area corresponding to the at least one second oral care position displaying in the second color different from the first color for the fifth duration. Further, the at least one display area corresponding to the at least one second oral care position flashes for the six duration after displaying in the second color for the fifth duration to remind the user that if the at least one second oral care position is not cared for, the oral care device will be turned off. In this way, the user is reminded that the at least one second oral care position does not meet the standard. Moreover, the power consumption of the oral care device is saved by turning off the oral care device after the at least one display area corresponding to the at least one second oral care position flashes in the second color for the six duration. The fifth duration may be, but is not limited to, 6 seconds, 4 seconds, etc., and the sixth duration may be, but is not limited to, 5 seconds, 3 seconds, etc. Therefore, the user has sufficient time to observe the information displayed in the display areas. In addition, since the display effect and the display duration of the at least one display area corresponding to the at least one first oral position are different from the display effect and the display duration of the at least one display area corresponding to the at least one second oral position, the user is strongly reminded that the at least one second oral care position is not properly cared for, thereby stimulating the user to strengthen oral care for the at least one second oral care position after the oral care is completed.

It is understood that the fourth duration may be the same as or different from the sixth duration, which is not limited thereto.

It is understood that after oral care is completed, when all of the oral care positions are well cared for (i.e., the oral care duration of each of the oral care positions reaches the respective predetermined duration), all of the oral care positions are defined as first oral care positions. That is, the at least one first oral care position comprises a plurality of first oral care positions. Alternatively, when none of the oral care positions are well cared for (i.e., the oral care duration of each of the oral care positions does not reach the respective predetermined duration), all of the oral care positions are defined as second oral care positions. That is, the at least one second oral care position comprises a plurality of second oral care positions. Alternatively, when the oral care positions are partially well cared for, there are one or more first oral care positions and one or more second oral care positions at the same time, which are determined based on the actual oral care situation and are not limited thereto.

In some possible embodiments, after the oral care device is powered on or woken up, the display areas of the oral care device are controlled to display a first oral care result of a previous oral care process according to predetermined rules, so as to remind the user of a previous oral care situation, thereby allowing the user to perform targeted oral care based on the first oral care result. The predetermined rules are to enable the display areas to display based on the display effects of the previous oral care situation, or the display areas can be displayed in other ways, which is not limited thereto.

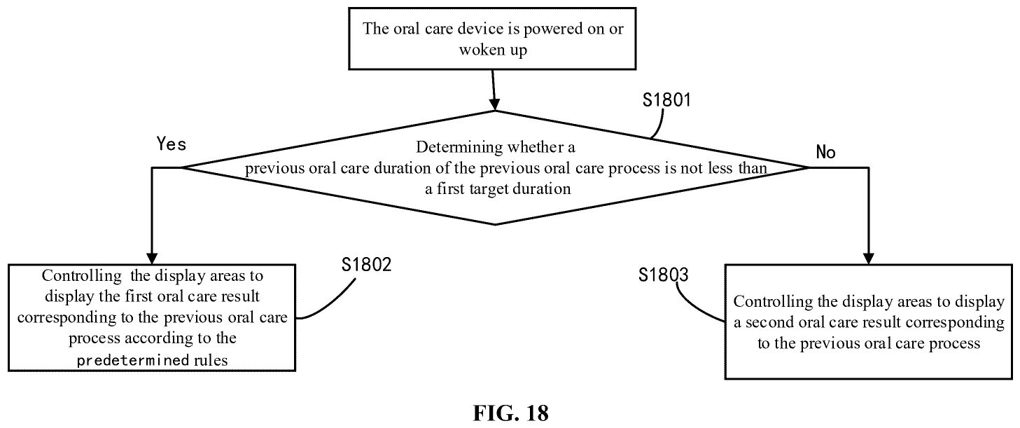

Furthermore, as shown in FIG. 18, after the oral care device is powered on or woken up, a process of controlling the display areas of the oral care device to display according to the predetermined rules comprises steps S1801-S1803.

The step S1801 comprises determining whether a previous oral care duration of the previous oral care process is not less than a first target duration.

Specifically, to avoid a problem of invalid display after the oral care device is powered on or woken up due to accidental activation or adjustment of the gear during oral care, it is first determined whether the previous oral care duration of the previous oral care process is not less than the first target duration. The first target duration may be, but is not limited to, 30 seconds, 40 seconds, etc.

The step S1802 comprises, if yes, controlling the display areas to display the first oral care result corresponding to the previous oral care process according to the predetermined rules.

Specifically, when the previous oral care duration is not less than the first target duration, the previous oral care process is considered effective. In this case, the display areas are controlled to display the first oral care result corresponding to the previous oral care process according to predetermined rules, which reminds the user of the previous oral care situation by displaying an effective previous oral care result (i.e., the first oral care result) after the oral care device is powered on or woken up, thereby enabling the user to accurately perform targeted oral care based on previous oral care situation.

The step S1803 comprises, if not, controlling the display areas to display a second oral care result corresponding to the previous oral care process.

Specifically, when the previous oral care duration of the previous oral care process is less than the first target duration, it is determined that the previous oral care process is performed due to a mis-start or the adjustment of the gear during the oral care process, which indicates that the previous oral care process is invalid. In this case, the display areas are controlled to display the second oral care result corresponding to a penultimate oral care process according to the predetermined rules. A penultimate oral care duration of the penultimate oral care process must be less than the first target duration. Thus, after the oral care device is turned on or woken up, the previous oral care result (i.e., the first oral care result) that is invalid is skipped, and a penultimate oral care result (i.e., the second oral care result) that is valid is displayed to effectively remind the user of a most recent oral care situation before the oral care device is turned on or woken up, allowing the user to accurately perform targeted oral care based on the penultimate oral care situation.

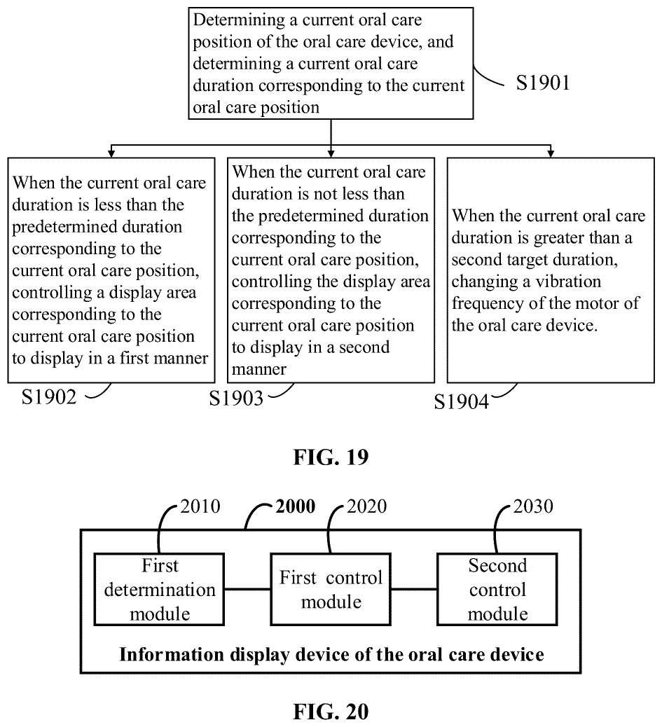

As shown in FIG. 19, FIG. 19 is another flow chart of the information display method of the oral care device according to one embodiment of the present disclosure. The information display method of the oral care device comprises steps S1901-S1904.

The step S1901 comprises determining a current oral care position of the oral care device, and determining a current oral care duration corresponding to the current oral care position.

Specifically, the step S1401 is the same as the step S1301, which is not described in detail herein.

The step S1902 comprises when the current oral care duration is less than the predetermined duration corresponding to the current oral care position, controlling a display area corresponding to the current oral care position to display in a first manner.

Specifically, the step S1902 is the same as the step S1303, which is not described in detail herein.

The step S1903 comprises when the current oral care duration is not less than the predetermined duration corresponding to the current oral care position, controlling the display area corresponding to the current oral care position to display in a second manner.

Specifically, the step S1903 is the same as the step S1304, which is not described in detail herein.

The step S1904 comprises when the current oral care duration is greater than a second target duration, changing a vibration frequency of the motor of the oral care device.

Specifically, during oral care, when the current oral care duration corresponding to the current oral care position is greater than the second target duration, it is considered that the current oral care position meets the standard or the care effect is excellent, and it is unnecessary to continue care for the current oral care position. Therefore, the vibration frequency of the motor of the oral care device is changed to indicate to the user that oral care for the current oral care position is no longer necessary, and the user is encouraged to switch the oral care device to the next oral care position. In this way, an excessive oral care duration at the same oral care position is avoided, and the oral care efficiency is not affected. To ensure the oral care effect at the current oral care position, the second target duration should not be less than the predetermined duration corresponding to the current oral care position, which may be, but is not limited to, 25 seconds, 30 seconds, etc.

FIG. 20 is a block diagram of an information display device of the oral care device according to one embodiment of the present disclosure. The information display device is applied to the oral care device. The oral care device comprises display areas. The display areas respectively display information of oral care positions. As shown in FIG. 20, the information display device 2000 comprises a first determination module 2010, a first control module 2020 and a second control module 2030.

The first determination module 2010 is configured to determine a current oral care position of the oral care device, and determine a current oral care duration corresponding to the current oral care position.

When the current oral care duration is greater than 0 and is less than a predetermined duration corresponding to the current oral care position, the first control module 2020 is configured to control a display area corresponding to the current oral care position to display in a first manner.

When the current oral care duration is not less than the predetermined duration corresponding to the current oral care position, the second control module 2030 is configured to control the display area corresponding to the current oral care position to display in a second manner. A display effect of the first manner is different from a display effect of the second manner.

In one optional embodiment, when an oral care duration of any one of non-current oral care positions is 0, a display area corresponding to the one of the non-current oral care positions is always displayed in a third manner. A display effect of the third manner is different from the display effect of the first manner and the display effect of the second manner.

In one optional embodiment, when an oral care duration of any one of non-current oral care positions is greater than 0 and less than a predetermined duration corresponding to the one of the non-current oral care positions, a display area corresponding to the one of the non-current oral care positions is always displayed in a third manner. A display effect of the third manner is different from the display effect of the first manner and the display effect of the second manner.

In one optional embodiment, when the oral care duration corresponding to any one of the non-current oral care positions is not less than a corresponding predetermined duration, the display area corresponding to the one of the non-current oral care positions is always displayed in the second manner.

In one optional embodiment, the information display device 2000 further comprises a first receiving module, a second determination module, a judgment module, a third control module, and a fourth control module. The first receiving module is configured to receive a pause instruction. In response to the pause instruction, the second determination module is configured to determine an oral care duration corresponding to each of the oral care positions. The judgment module is configured to determine whether the oral care duration corresponding to each of the oral care positions is not less than a predetermined duration corresponding to each of the oral care positions. If yes, for each of the oral care positions, the third control module is configured to control a corresponding display area to display in the second manner. If not, for each of the oral care positions, the fourth control module is configured to control the corresponding display area to display in a third manner. A display effect of the third manner is different from the display effect of the first manner and the display effect of the second manner.

In one optional embodiment, when the oral care device is not triggered within a first duration after receiving the pause instruction, for each of the oral care positions, the third control module is specifically configured to control the corresponding display area to light up in a first color for a second duration, then flash the corresponding display area for a third duration, and turn off the corresponding display area. When the oral treatment device is not triggered within the first duration after receiving the pause instruction, for each of the oral care positions, the fourth control module is specifically configured to control a corresponding display area to display with a solid light in a second color for the second duration, then flash the corresponding display area for the third duration, and turn off the corresponding display area. The first duration is equal to a sum of the second duration and the third duration; and the first color is different from the second color.

In one optional embodiment, the information display device further comprises a second receiving module, a fifth control module, and an execution module. The second receiving module is configured to receive a mode switching instruction. In response to the mode switching instruction, the fifth control module is configured to control the display areas to display in a third manner. After the oral care device starts an oral care operation in a switched mode after the mode switching instruction is functioned, the execution module executes the step of determining the current oral care position of the oral care device and determining the current oral care duration corresponding to the current oral care position. A display effect of the third manner is different from the display effect of the second manner.

In one optional embodiment, the information display device further comprises a sixth control module. After a total oral care duration of the oral care device reaches a predetermined total duration or after an oral care operation of the oral care device ends, when there is at least one first oral care position in the oral care positions, the sixth control module is configured to control at least one display area, corresponding to the at least one first oral care position, of the display areas, to display in the second manner. When there is at least one second oral care position in the oral care positions, the sixth control module is configured to control at least one display area, corresponding to the at least second oral care position, of the display areas, to display in a third manner. The at least one first oral care position represents at least one of the oral care positions each having an oral care duration not less than a corresponding predetermined duration. The at least one second oral care position represents at least one of the oral care positions each having an oral care duration less than a corresponding predetermined duration. A display effect of the third manner is different from the display effect of the first manner and the display effect of the second manner.

In one optional embodiment, when controlling the at least one display area corresponding to the at least one first oral care position to display in the second manner comprises: the sixth control module is specifically configured to flash the at least one display area corresponding to the at least one first oral care position in a first color for a fourth duration, and turn off the at least one display area corresponding to the at least one first oral care position. When controlling the at least one display area corresponding to the at least second oral care position to display in the third manner, the sixth control module is specifically configured to control the at least one display area corresponding to the at least one second oral care position to light up in a first color for a fifth duration, flash the at least one display area corresponding to the at least one second oral care position for a sixth duration, and turn off the at least one display area corresponding to the at least one second oral care position. The first color is different from the second color.

In one optional embodiment, the information display device comprises a second control module. After the oral care device is powered on or woken up, the seven control module is configured to control the display areas of the oral care device to display a first oral care result of a previous oral care process according to predetermined rules.

In one optional embodiment, the seventh control module comprises a judgment unit, a first control unit, and a second control unit. The judgment unit is configured to determine whether a previous oral care duration of the previous oral care process is not less than a first target duration. If yes, the first control unit is configured to control the display areas to display the first oral care result corresponding to the previous oral care process according to the predetermined rules. If not, the second control unit is configured to control the display areas to display a second oral care result corresponding to the previous oral care process.

In one optional embodiment, the information display device 2000 further comprises an eighth control module. When the current oral care duration is greater than a second target duration, the eighth control module is configured to change a vibration frequency of the motor of the oral care device.

In one optional embodiment, when a dwell duration of the oral care device at a third oral care position exceeds a third target duration, the first determination module is configured to determine the third oral care position as the current oral care position.

In one optional embodiment, the first manner may comprise, but is not limited to, a flashing light display; the second manner may comprise, but is not limited to, displaying in first color; and the third manner comprises displaying in a second color. The flashing light display comprises at least one of the following modes: alternating flashing with the first color and the second color; a first light-emitting unit in the display area corresponding to the one of the oral care positions remaining constantly lit with the first color; and a second light-emitting unit thereof flashing with the second color, flashing with the first color, and flashing with the second color, etc. The first color is different from the second color.

In one optional embodiment, the oral care device comprises a handle and a brush head. A button is disposed on the handle. The display areas are defined on a surface, where the button is located, of the handle. The display areas are located between the brush head and the button. The display areas are distributed according to a distribution of the oral care positions.

In one optional embodiment, the display areas are connected end to end to form a display ring.

In one optional embodiment, the handle comprises a housing and a power component. The display ring is light-transmitting and is embedded in the housing. Light-emitting units corresponding to the display areas are disposed on the power component. When each of the light-emitting units emits light, a corresponding display area is lit up.

In one optional embodiment, two sub-display areas are defined within the display ring. The two sub-display areas are spaced apart in a circumferential direction of the handle. The two sub-display areas are spaced apart from the display ring. The two sub-display areas are displayed in a fourth manner.

The division of modules in the information display device of the oral care device described above is for illustrative purposes only. In other embodiments, the information display device of the oral care device may be divided into different modules as needed to complete all or part of the functions of the information display device of the oral care device. The implementation of each module in the information display device of the oral care device provided in the embodiments maybe in a form of a computer program. The computer program is able to be run on the oral care device, a terminal, or a server. A program module containing the computer program may be stored in a memory of the oral care device, the terminal, or the server. When the computer program is executed by a processor, the computer program implements all or part of the steps of the information display method of the oral care device of the embodiments of the present disclosure.

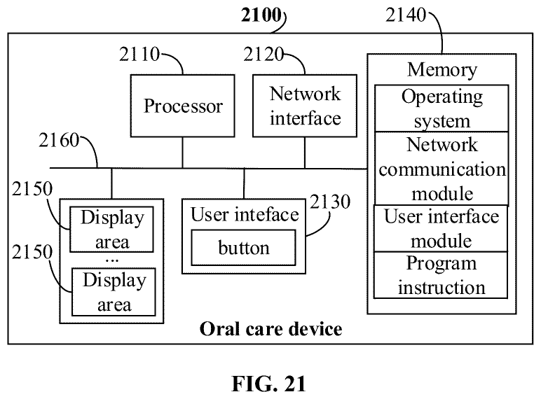

As shown in FIG. 21, FIG. 21 is another block diagram of the information display device of the oral care device according to one embodiment of the present disclosure. As shown in FIG. 21, the oral care device 2100 comprises at least one processor 2110, at least one network interface 2120, a user interface 2130, a memory 2140, display areas 2150, and at least one communication bus 2160.

The at least one communication bus 2160 is configured to realize connection and communication between the various components of the oral care device 2100.

The at least one network interface 2120 comprises a BLUETOOTH module, a near field communication (NFC) module, a wireless fidelity (Wi-Fi) module, etc.

The user interface 2130 comprises a button. Optionally, the user interface 2130 may further comprise a standard wired interface or a wireless interface.

The display areas 2150 are configured to respectively display information of oral care positions.

The at least one processor 2110 comprises one or more processing cores. The at least one processor 2110 uses various interfaces and lines to connect various parts of the oral care device 2100. The processor 2110 executes various functions and processes data of the oral care device 2100 by running or executing instructions, programs, code sets or instruction sets stored in the memory 2140, and calling data stored in the memory 2140. Optionally, the at least one processor 2110 is implemented by at least one hardware of a digital signal processing (DSP), a field programmable gate array (FPGA), and a programmable logic array (PLA). The at least one processor 2110 may integrate one or a combination of a central processing unit (CPU), a graphics processing unit (GPU), and a modem. The CPU mainly processes an operating system and an application for the oral care device 2100. The GPU is responsible for rendering and drawing content to be displayed on the display screen. The modem is configured to process wireless communications. It is understood that the modem may not be integrated into the at least one processor 2110, but implemented by a chip.

The memory 2140 may be random access memory (RAM) or read-only memory (ROM). Optionally, the memory 2140 may be a non-transitory computer-readable medium. The memory 2140 is configured to store the instructions, the programs, the codes, the code sets or the instruction sets. The memory 2140 comprises a program storage area and a data storage area. The program storage area stores the instructions for implementing the operating system, the instructions for at least one function (such as a receiving function, a control function, a determination function, etc.), the instructions for implementing the controls method of the present disclosure, etc. The data storage area stores data involved in the control method of the present disclosure, etc. Optionally, the memory 2140 may be at least one storage device located away from the at least one processor 2110. As shown in FIG. 21, the memory 2140 served as a computer storage medium may comprise the operating system, a network communication module, a user interface module, and program instructions.

In some possible embodiments, the processor 2110 is configured to call the program instructions stored in the memory 2140 and specifically execute the information display method of the oral care device, which is not repeatedly described herein.

In the above embodiments, the present disclosure may be implemented in whole or in part by software, hardware, firmware or any combination thereof. When implemented by software, the software is implemented in whole or in part in the form of a computer program product. The computer program product comprises one or more computer instructions. When the one or more computer program instructions are loaded and executed on the computer, the process or function described in the embodiments of the present disclosure is generated in whole or in part. The computer may be a general-purpose computer, a special-purpose computer, a computer network, or other programmable device. The one or more computer instructions may be stored in the computer-readable storage medium or transmitted through the computer-readable storage medium. The one or more computer instructions may be transmitted from a website site, a computer, a server, or a data center to another website site, another computer, another server or another data center by wired (e.g., coaxial cable, optical fiber, digital subscriber line) or wireless (e.g., infrared, wireless, microwave, etc.) mode. The computer-readable storage medium may be any available medium that is able to be accessed by the computer or a data storage device such as the server or the data center that comprises one or more available media integrated. The one or more available media may be a magnetic medium (e.g., a floppy disk, a hard disk, a magnetic tape), an optical medium (e.g., a digital versatile disc (DVD)), or a semiconductor medium (e.g., a solid state disk (SSD)).

Those skilled in the art can understand that all or part of the processes in the above-mentioned embodiments can be implemented by instructing the relevant hardware through the computer programs, and the computer programs may be stored in the computer-readable storage medium. When the computer programs are executed, the processes of the embodiments of the present disclosure are executed. The storage medium comprises the ROM, the RAM, a magnetic disk, an optical disk, or other media that are able to store the program codes. In the absence of conflict, the technical features in the embodiments and implementation schemes of the present disclosure can be combined arbitrarily.

The above embodiments are merely illustrative of the optional embodiments of the present disclosure and are not intended to limit the scope of the present disclosure. Various modifications and improvements made by those of ordinary skill in the art to the technical solutions of the present disclosure shall fall within the protection scope defined by the claims of the present disclosure without departing from the spirit of the present disclosure.

What is claimed is:

1. An information display method of an oral care device, wherein the information display method is applied to the oral care device, the oral care device comprises display areas, and the display areas are configured to respectively display information of oral care positions; wherein the information display method comprising:
determining a current oral care position of the oral care device, and determining a current oral care duration corresponding to the current oral care position;
when the current oral care duration is less than a predetermined duration corresponding to the current oral care position, controlling a display area corresponding to the current oral care position to display in a first manner; and
when the current oral care duration is not less than the predetermined duration corresponding to the current oral care position, controlling the display area corresponding to the current oral care position to display in a second manner;
wherein a display effect of the first manner is different from a display effect of the second manner.

2. The information display method according to claim 1, wherein when an oral care duration of any one of non-current oral care positions is 0, a display area corresponding to the one of the non-current oral care positions is always displayed in a third manner;
wherein a display effect of the third manner is different from the display effect of the first manner and the display effect of the second manner, or the display effect of the third manner is the same as the display effect of the first manner.

3. The information display method according to claim 1, wherein when an oral care duration of any one of non-current oral care positions is greater than 0 and less than a predetermined duration corresponding to the one of the non-current oral care positions, a display area corresponding to the one of the non-current oral care positions is always displayed in a third manner;
wherein a display effect of the third manner is different from the display effect of the first manner and the display effect of the second manner, or the display effect of the third manner is the same as the display effect of the first manner.

4. The information display method according to claim 1, wherein when the oral care duration corresponding to any one of the non-current oral care positions is not less than a predetermined duration corresponding to the one of the non-current oral care positions, the display area corresponding to the one of the non-current oral care positions is always displayed in the second manner.

5. The information display method according to claim 1, wherein the information display method further comprises:
receiving a pause instruction;
in response to the pause instruction, for each of the oral care positions, determining a corresponding oral care duration;
for each of the oral care positions, determining whether the corresponding oral care duration is not less than a corresponding predetermined duration;
if yes, for each of the oral care positions, controlling a corresponding display area to display in the second manner; and
if no, for each of the oral care positions, controlling the corresponding display areas to display in a third manner;
wherein a display effect of the third manner is different from the display effect of the second manner.

6. The information display method according to claim 5, wherein for each of the oral care positions, the controlling the corresponding display area to display in the second manner comprises:
when the oral care device is not triggered within a first duration after receiving the pause instruction, controlling the corresponding display area to light up in a first color for a second duration, then flashing the corresponding display area for a third duration, and turning off the corresponding display area;
wherein for each of the oral care positions, the controlling the corresponding display areas to display in the third manner comprises:
when the oral treatment device is not triggered within the first duration after receiving the pause instruction, controlling the corresponding display area to light up in a second color for the second duration, then flashing the corresponding display area for the third duration, and turning off the corresponding display area;
wherein the first duration is equal to a sum of the second duration and the third duration, and the first color is different from the second color.

7. The information display method according to claim 1, wherein the information display method further comprises:
receiving a mode switching instruction;
in response to the mode switching instruction, controlling the display areas to display in a third manner; and
after the oral care device starts an oral care operation in a switched mode after the mode switching instruction is functioned, determining the current oral care position of the oral care device and determining the current oral care duration corresponding to the current oral care position;
wherein a display effect of the third manner is different from the display effect of the second manner.

8. The information display method according to claim 1, wherein the information display method further comprises:
after a total oral care duration of the oral care device reaches a predetermined total duration or after an oral care operation of the oral care device ends, when there is at least one first oral care position in the oral care positions, controlling at least one display area corresponding to the at least one first oral care position to display in the second manner, and when there is at least one second oral care position in the oral care positions, controlling at least one display area corresponding to the at least second oral care position to display in a third manner;
wherein the at least one first oral care position represents at least one of the oral care positions each having an oral care duration not less than a corresponding predetermined duration, and the at least one second oral care position represents at least one of the oral care positions each having an oral care duration less than a corresponding predetermined duration;
wherein a display effect of the third manner is different from the display effect of the second manner.

9. The information display method according to claim 8, wherein the controlling the at least one display area corresponding to the at least one first oral care position to display in the second manner comprises:
flashing the at least one display area corresponding to the at least one first oral care position in a first color for a fourth duration, and turning off the at least one display area corresponding to the at least one first oral care position;
wherein the controlling the at least one display area corresponding to the at least second oral care position to display in the third manner comprises:
controlling the at least one display area corresponding to the at least one second oral care position to light up in a first color for a fifth duration, flashing the at least one display area corresponding to the at least one second oral care position for a sixth duration, and turning off the at least one display area corresponding to the at least one second oral care position;
wherein the first color is different from the second color.

10. The information display method according to claim 1, wherein information display method further comprises:
after the oral care device is powered on or woken up, controlling the display areas of the oral care device to display a first oral care result of a previous oral care process according to predetermined rules.

11. The information display method according to claim 1, wherein the oral care device comprises a handle and a brush head; and a button is disposed on the handle;
wherein the display areas are defined on a surface, where the button is located, of the handle, the display areas are located between the brush head and the button, and the display areas are distributed according to a distribution of the oral care positions.

12. The information display method according to claim 11, wherein the handle comprises a housing and a power component,
wherein light-emitting units corresponding to the display areas are disposed on the power component, the display areas are connected end to end to form a display ring, and the display ring is light-transmitting and is embedded in the housing;
wherein when each of the light-emitting units emits light, a corresponding display area is lit up.

13. The information display method according to claim 11, wherein the display areas are connected end to end to form a display ring, two sub-display areas are defined within the display ring, the two sub-display areas are spaced apart in a circumferential direction of the handle, the two sub-display areas are spaced apart from the display ring; and the two sub-display areas are displayed in a fourth manner.

14. An oral care device, comprising:
display areas;
a memory; and
a processor;
wherein the display areas are respectively configured to display information of oral care positions;
wherein the memory is connected to the processor, the memory is configured to store executable program codes, and the processor runs a program corresponding to the executable program codes by reading the executable program codes stored in the memory;
wherein the processor is configured to:
determine a current oral care position of the oral care device, and determine a current oral care duration corresponding to the current oral care position,
when the current oral care duration is less than a predetermined duration corresponding to the current oral care position, control a display area corresponding to the current oral care position to display in a first manner, and
when the current oral care duration is not less than the predetermined duration corresponding to the current oral care position, control the display area corresponding to the current oral care position to display in a second manner;
wherein a display effect of the first manner is different from a display effect of the second manner.

15. An oral care device, comprising:
a handle; and
a care element;
wherein the care element is connected to the handle and works under an action of the handle;
wherein the handle comprises a power component and a housing, the housing defines a light-transmitting area; light-emitting units are disposed on the power component, and the light-emitting units are disposed corresponding to the light-transmitting area;
wherein the power component comprises a control unit, the control unit is connected to the light-emitting units, the control unit is configured to receive current oral care information and control the light-emitting units to work according to the current oral care information.

16. The oral care device according to claim 15, wherein the power component further comprises a detection element, and the detection element is connected to the control unit and is configured to detect the current oral care information of the oral treatment device; and/or
the current oral care information comprises a current oral care duration of the oral care device, the handle further comprises a timer, and the timer is connected to the control unit;
wherein the timer is configured to count the current oral care duration of the oral care device, and the control unit is configured to control the light-emitting units to work according to the current oral care duration.

17. The oral care device according to claim 15, wherein the light-transmitting area comprises light-transmitting sub-areas, and the light-transmitting sub-areas are spaced apart and are disposed annularly along a circumferential direction of the handle.

18. The oral care device according to claim 15, wherein the light-emitting units are disposed at intervals, the light-emitting units are correspondingly to the light-transmitting area, or
the light-transmitting area comprises light-transmitting sub-areas, and each of the light-transmitting sub-areas is corresponding to one or more of the light-emitting units.

19. The oral care device according to claim 15, wherein a gap between surfaces of the light-emitting units and an inner surface of the housing is greater than 0.8 mm and less than 2 mm.

20. The oral care device according to claim 15, wherein a light guide piece is disposed on an inner wall of the housing, protruding columns extending inwardly are disposed on the housing, the light guide piece comprises through holes, the protruding columns respectively extend into the through holes, and the light guide piece is integrally formed with the housing; and/or
the light-transmitting area protrudes from a holding portion of the handle, and a protruding height of the light-transmitting area is 0.5-3 mm; and/or
the light-transmitting area comprises an upper light-transmitting sub-area and a lower light-transmitting sub-area, one of the oral care positions corresponding to the upper light-transmitting sub-area is an upper teeth area, and one of the oral care positions corresponding to the lower light-transmitting sub-area is a lower teeth area.
